(19) United States
(12) Patent Application Publication
(10) Pub. No.: US 2022/0358509 A1
(43) Pub. Date: Nov. 10, 2022

(54) Methods and System for Authorizing a Transaction Related to a Selected Person

(71) Applicant: Kinectify, Inc., Las Vegas, NV (US)

(72) Inventors: Joseph Martin, Scottsdale, AZ (US); Michael Calvin, Escondido, CA (US)

(21) Appl. No.: 17/740,994

(22) Filed: May 10, 2022

Related U.S. Application Data
(60) Provisional application No. 63/186,652, filed on May 10, 2021.

(51) Int. Cl. G06Q 20/40

(52) U.S. Cl. CPC G06Q 20/4016

(57) ABSTRACT

Methods and systems are described herein for providing an evaluation system and an improved user interface to assist with decision making regarding particular operations. The evaluation system may collect, collate, store, and evaluate information from multiple sources and data of multiple types. The improved user interface may acquire, store, process, and display such relevant information efficiently and compactly for making an authorization decision. An evaluation system uses this data to create assessment scores for multiple people being evaluated for a variety of factors. The combined scores are displayed on the improved user interface for enabling improved visualization to decide if a particular operation is approved or denied.

### CROSS-REFERENCE TO RELATED APPLICATIONS

This application claims priority to U.S. provisional patent application 63/186,652 filed May 10, 2021 which is hereby incorporated by reference herein in its entirety.

### TECHNOLOGICAL AREA

This application is related to an improved system and user interface for acquiring, collating, storing, tracking, and displaying information related to authorization of a transaction and in particular to techniques for computing an evaluation score related to a person or persons to authorize or deny the transaction and for displaying evaluation information for a person or persons related to such scores.

### SUMMARY

Modern networks and systems commonly face a problem of whether to proceed with particular operations. In one approach, a transaction related to a person that involves the transfer of sensitive information may be evaluated based on a number of criteria, such as the person's relationships, place of business, and the person's location. However, with a large amount of available information from multiple sources and with data of multiple types, it is difficult for such systems to collect, collate, store, and evaluate such information to come to a decision as to processing of the information. Furthermore, interfaces for acquiring, storing, and displaying such information are deficient in that they fail to compactly display the relevant information for making an authorization decision. In particular, a large amount of data required to evaluate critical transactions is simply impossible to display on a display of a limited size, even when a single person is being evaluated. The task is even more difficult when several related people related to the information are evaluated for a decision.

Such evaluations may be particularly critical in the context of authorization of transactions, in which underlying decisions have consequences for multiple stakeholders, such as the person seeking authorization of the transaction, the entity performing the transaction, and third parties. Many such entities perform transactions outside of the traditional frameworks employed by financial institutions but may nonetheless be subject to similar and ever-expanding requirements such as anti-money laundering, terrorism watch lists, and the like. Such requirements may further be difficult to integrate with an institution's own requirements and systems, limiting the ability of such an institution to layer on their own unique criteria for validating transactions in a manner that enhances efficient system operation, compact data storage and processing, customer satisfaction, and organizational profitability. Existing systems are unable to access and efficiently process the relevant underlying information from multiple sources, including sources that dictate logic to be used for data analysis, and the underlying data to which the logic is applied. Displays and evaluation tools (automatic or manual) are unable to effectively access, process, and evaluate such dispersed and disparate data, making evaluation and compliance by entities that perform transactions inconsistent and ineffective, and particularly limiting the ability to create and integrate bespoke data processing solutions.

To solve this problem a robust evaluation system is needed that is capable of managing data from multiple sources, collating the data and documents, analyzing the data to create assessment scores for multiple people being evaluated for a variety of factors, and creating combined scores and data visualizations that enable a decision (e.g., a decision for a device on whether to allow or decline a transaction). Data is obtained, integrated, processed, managed, and presented in a manner that reduces network traffic, processing times, redundant storage of information, and optimizes use of available user interfaces. In addition, the evaluation system provides a robust graphical interface for enabling visualization of the collected data, improved visualization of combined assessment scores (e.g., display of scores for multiple related people associated with a transaction), and an improved communication interface for enabling secure transfer of information.

The evaluation system may receive (e.g., via a user interface) a request to evaluate a selected person who is associated with the transaction. The system may acquire data such as by searching internal and external data sources (e.g., via one or more private and public networks) to acquire data from multiple services (e.g., first and second data). For example, first data may be received over a local network, and second data may be received (e.g., in encrypted form) via an external source such as a private network, the Internet, or another public network.

The evaluation system may use both the first and second data to calculate a plurality of assessment scores for a plurality of evaluation categories. For example, a score may be calculated for each one of the following factors: geography category, licenses category, industry category, any other suitable category, or combinations thereof. The evaluation system may then calculate a combined score based on the plurality of assessment scores and based on a weight associated with each of the plurality of evaluation categories. Aspects of the weights may be are predetermined by the system (e.g., in accordance with regulatory requirements), while other aspects of the weights may be inputted or adjusted by a user via a displayed user interface. In some embodiments the categories may be preset or selected via user input (e.g., via a user interface that shows a superset of categories and allows the user to select a smaller set).

In some embodiments, the evaluation system may identify a plurality of additional persons that are identified as related to the selected person. For example, the evaluation system may identify that the additional person may share a common address with the select person, the evaluation system may identify the additional person as family or other relation of the selected person, the evaluation system may identify the additional person as connected to the selected person via a social network, and/or the evaluation system may identify the additional person as a co-worker or business associate of the selected person. The evaluation system may identify the additional person as related to the selected person in any other suitable manner, or by any combination of the aforementioned factors. The scores of other persons may also affect the calculation of the combined score of the selected person, in manners that may be predetermined or modifiable by a user of the system.

Once the related persons are identified, the system may retrieve or calculate a combined score for each such person based on similar criteria to the person being evaluated. For example, system may compute the score using the process discussed above for the selected person. The evaluation system may then generate for display an improved user interface showing: an identifier (e.g., a name, photo, avatar, customer number, or other identifying information) of the selected person. The improved user interface may also include a visual representation of the calculated combined score associated with the selected person. For example, a numerical score is displayed. In some embodiments, the numerical score is augmented or replaced with a visual indicator (e.g., color coded or heat-mapped markers corresponding to “low,” “medium,” “high,” or other suitable categories may be used with or instead of the raw score.). The visual representation of the calculated combined score may appear in a suitable location (e.g., adjacent to) relative to the identifier of the selected person.

In some embodiments, once the combined score is computed the evaluation system may cause a transaction associated with the selected person to be executed or prevented. For example, the combined score compared to a threshold (e.g., exceeding or failing to surpass the threshold, depending on the threshold type) may lead to a command being sent to a transaction system (e.g., a system that handles money, asset, or data transfers) to execute or deny one or more transactions associated with the selected person and/or any associated persons. In other embodiments, the score exceeding the threshold may lead to particular transactions (e.g., a request to transfer of money, assets, or data) that is associated with the selected person to be denied. For example, the score is sent to a system tasked with transaction, causing the system to stop the transaction. The user interface may also provide tools for the user of the system to modify and/or override the criteria, such as by modifying thresholds for combine scores, weightings for combined scores, inputs, or simply a general override (e.g., provided with a cryptographically signed authorization).

In some embodiments, the improved user interface may also include a visual representation of relationships between the selected person and the plurality of additional persons. For example, the visual representation of relationships may appear as a graph showing the links that led to the determination of relatedness. Such a visual representation of relationships may appear simultaneously with the score for the selected person, or on a separate page connected via hyperlink to the page showing the score for the selected person. In this case, the user interface may display a visual representation of relationships (e.g., by clicking a hyperlink), and in some embodiments, a visual or numerical representation of the estimated strength of the underlying relationship with the person under evaluation. Combined scores and/or visual depictions thereof may also be displayed for the additional persons.

In some embodiments, the evaluation system may be configured to generate for display a secure messaging interface for communication with an external system that evaluates the selected person (e.g., with another system that needs to evaluate the selected person in connection with another transaction). The evaluation system may then receive such messages via secure messaging interface and transmitted to the external system in an encrypted form. If the other system is a similar evaluation system, the messages may appear in a similar interface.

Otherwise, the evaluation system may send the messages via encrypted email. In addition, if encrypted email messages are received, they may be decrypted and shown via the secure messaging interface.

### BRIEF DESCRIPTION OF THE DRAWINGS

The above and other features of the present disclosure, its nature, and various advantages will be more apparent upon consideration of the following detailed description, taken in conjunction with the accompanying drawings in which:

FIG. 1 depicts a block diagram of an exemplary evaluation system in accordance with some embodiments of the disclosure;

FIGS. 2A and 2B are examples of illustrative steps for displaying a selected person's combined risk scores, associated information, and related persons' combined risk scores and information, in accordance with some embodiments of the disclosure;

FIG. 3 shows an illustrative example of a user interface display screen of the evaluation system in accordance with some embodiments of the disclosure;

FIG. 4 shows an illustrative example of a user interface display screen of the evaluation system displaying an information mapping tool in accordance with some embodiments of the disclosure;

FIG. 5 shows an illustrative example of an improved user interface of the evaluation system displaying a selected persons profile in accordance with some embodiments of the disclosure;

FIG. 6 shows an illustrative example of an improved user interface of the evaluation system displaying a customer profile settings display screen that allows risk factor parameters to be customizable in accordance with some embodiments of the disclosure;

FIG. 7 shows an illustrative example of an improved user interface of the evaluation system displaying a risk score tool in accordance with some embodiments of the disclosure;

FIG. 8 shows an illustrative example of an improved user interface of the evaluation system displaying a communication interface in accordance with some embodiments of the disclosure;

FIGS. 9A and 9B are flowcharts of illustrative steps for computing an evaluation score with the evaluation system and for displaying such scores with the improved user interface in accordance with some embodiments of the disclosure;

FIG. 10 shows an illustrative example of an improved user interface of the evaluation system displaying an activity log interface in accordance with some embodiments of the disclosure;

FIG. 11 depicts an improved user interface of the evaluation system displaying detailed risk categorizations;

FIG. 12 depicts an improved user interface of the evaluation system displaying risk activity visualizations;

FIG. 13 depicts an improved user interface of the evaluation system displaying risk activity reporting;

FIG. 14 depicts an improved user interface of the evaluation system including a reporting status display;

FIG. 15 depicts an improved user interface of the evaluation system including a suspicious activity display;

FIG. 16 depicts an improved user interface of the evaluation system including a selection of suspicious activity details within a suspicious activity display; and

FIG. 17 depicts an improved user interface of the evaluation system including a risk assessment workflow display.

### DETAILED DESCRIPTION

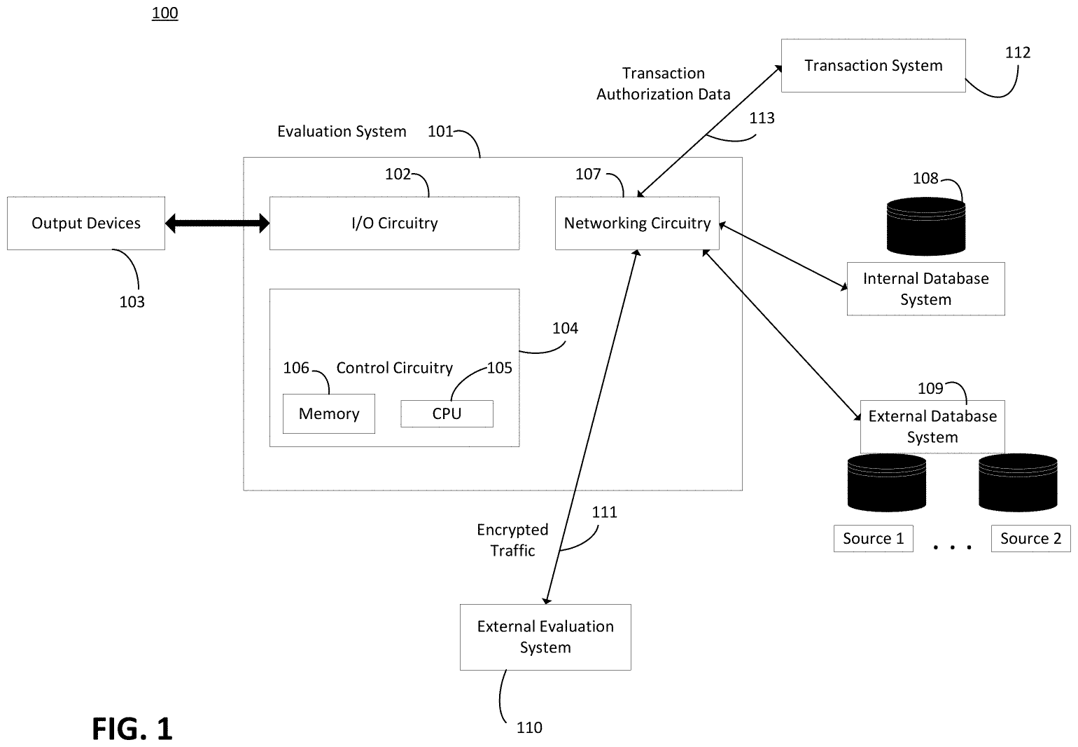

FIG. 1 depicts a block diagram 100 of an exemplary evaluation system. Although particular components are depicted in a particular arrangement in FIG. 1, it will be understood that components may be added, modified, and arranged in a variety of manners in accordance with the present disclosure. The evaluation system 101 may include an input/output circuitry 102 (hereinafter “I/O”) for displaying a variety of user interfaces via output devices 103. I/O circuitry 102 may be a suitable input interface, such as a mouse, keypad, keyboard, touch screen, touchpad, stylus input, voice recognition interface, haptic interface, or other input interfaces. I/O circuitry 102 may also include an interface for communicating with other devices such as output devices 103. Output devices 103 may be any suitable display interface, such as a computer display screen, mobile device, television display screen, augmented reality display (e.g., glasses or other screen overlay over a user's field of vision), virtual reality display, or other output display devices. It will be understood that in some instances particular output devices 103 may include both input and output and output functionality, such as a tablet or AR display.

I/O circuitry 102 may provide information (e.g., selected persons information, internet information, information available over a local area network (LAN) or wide area network (WAN), and/or other information) and data to control circuitry 104. Control circuitry 104 which includes a processor 105 and memory 106 may be included for performing data evaluation related to a selected person operations and other necessary processing steps. Control circuitry 104 may be used to process information and send and receive commands, requests, and other suitable data using the I/O circuitry 102. I/O circuitry 102 may connect control circuitry 104 (processing circuitry 105 and memory 106) to networking circuitry 107.

Control circuitry 104 may be based on any suitable processing circuitry such as processing circuitry 105. As referred to herein, processing circuitry should be understood to mean circuitry based on one or more microprocessors, microcontrollers, digital signal processors, programmable logic devices, application-specific integrated circuits, etc., and may include a multi-core processor. In some embodiments, the control circuitry 104 executes instructions stored in memory 106 for rendering and depicting an improved user interface application. Specifically, control circuitry 104 may be execute instructions to render and display an improved user interface of the evaluation system to perform the functions discussed above and below. For example, the control circuitry 104 may create an integrated display that describes an individual and includes information about the suitability of a transaction such as a combined evaluation score, relationships with third parties, and combined scores for those third parties.

Memory 106 may be an electronic storage device that is part of control circuitry 104, although in some embodiments memory may be located at other components or locations or in whole or in part (e.g., at additional control circuitry, a locally networked drive, a public cloud, etc.). As referred to herein, memory should be understood to mean any device for storing electronic data, computer software, or firmware, such as random-access memory, read-only memory, hard drives, optical drives, solid state devices, quantum storage devices, or any suitable fixed or removable storage devices, and/or any combination of the same. Memory 106 may be used to store various types of information described herein, including instructions for performing the evaluations, display renderings, communications, and other operations described herein.

The evaluation system 101 may include networking circuitry 107 which may communicate via public and/or private networks to internal 108 and/or external 109 data source (e.g., database servers) and/or other data sources. The networking circuitry 107 may also securely communicate with the internal data source(s) 108, external data source(s) 109, and other evaluation systems 110 via encrypted traffic 111. The networking circuitry 107 may also communicate transaction authorization data 113 (e.g., receive authorization requests, receive transaction or user related information, transmit evaluation results, etc.) with a transaction system 112 (e.g., a system that may execute further steps such as transferring money, assets, or data associated with the selected person) to enable or prevent a transaction. The system of FIG. 1 and any of its components may be a single device, a virtual system, or a distributed system distributed across multiple devices. An internal data source is a data source that is associated with the entity that is operating the evaluation system, and may include information that is stored locally on a device, on local servers, or on remote servers or other data sources operated by or for the entity that is operating the evaluation system, such as an entity where an individual is attempting to engage in a transaction (e.g., a gaming facility, controlled substance dispensary, cryptocurrency custodian, etc.). An external data source is a data source of any type (e.g., drives, computers, servers, etc.) operated by or for other entities, such as regulators.

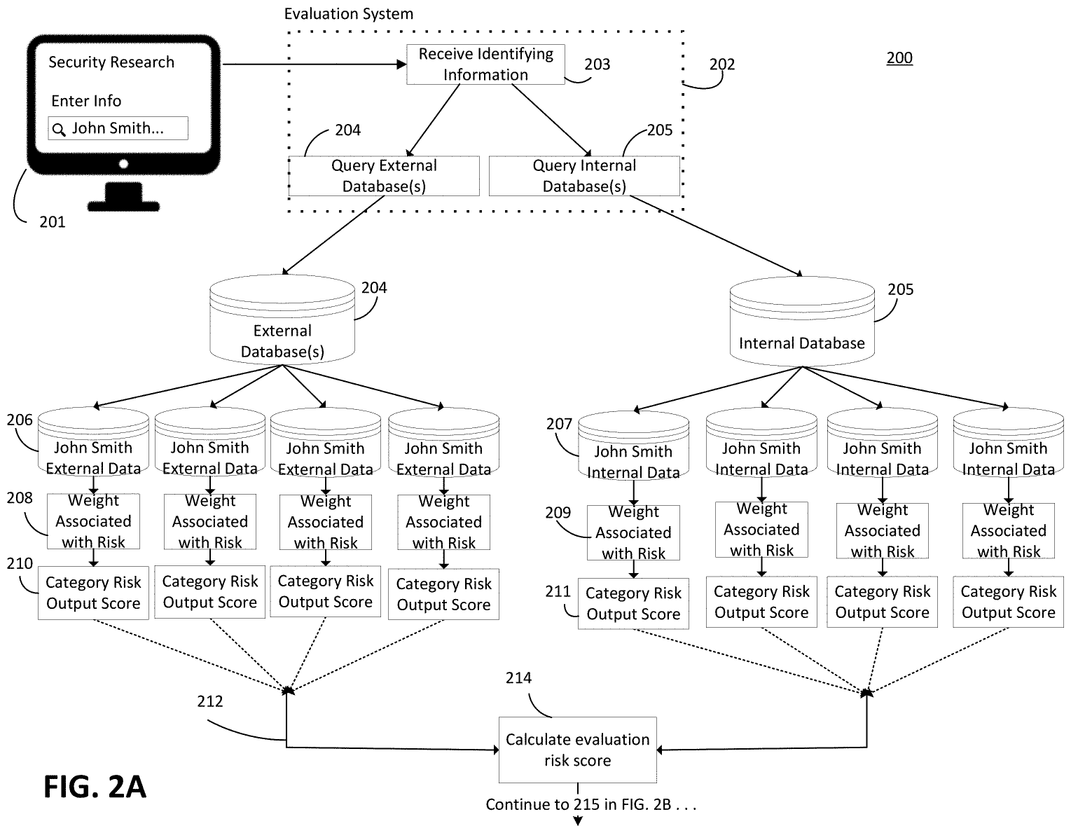

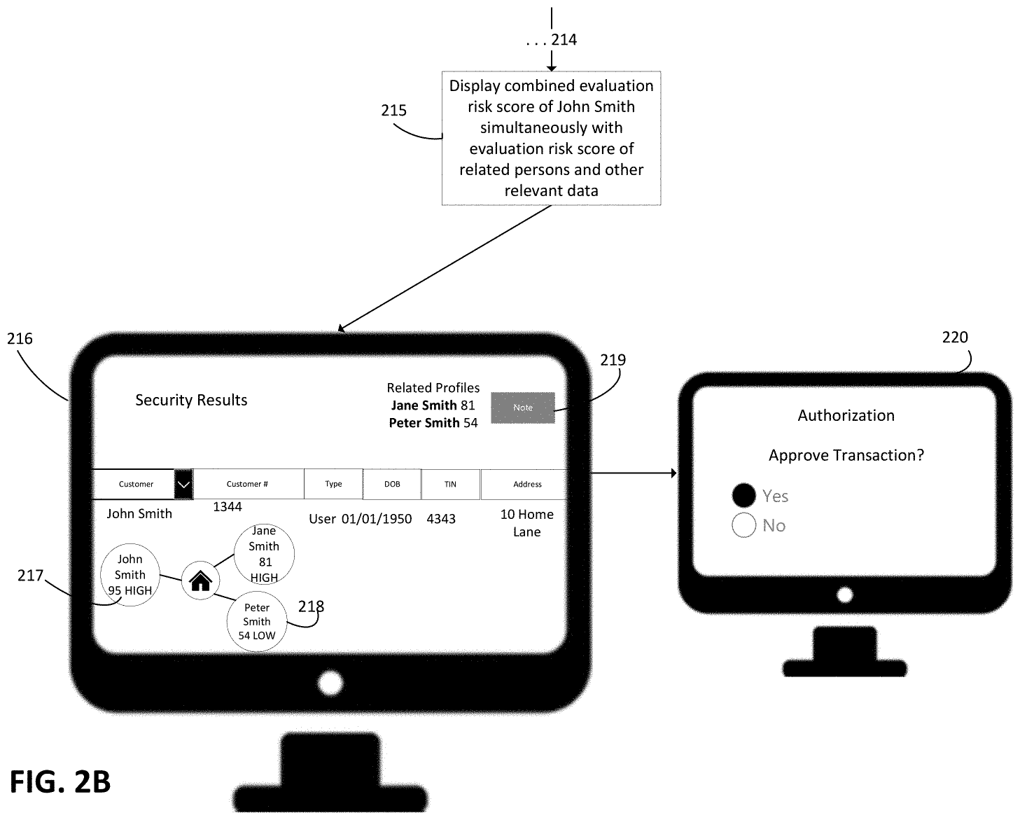

FIGS. 2A and 2B depict steps for displaying selected persons' combined risk scores, associated information, and related persons' combined risk scores 200. The user interface may receive a selected person's information 201 (e.g., the name “John Smith” is entered via the output device 103 of FIG. 1), although in some embodiments multiple persons may be selected for evaluation or identifying information related to the selected person may be received (e.g., photographs, video, still images, user biometric data, etc.). The evaluation system 202 may receive the input of identifying information 203 (e.g., I/O circuitry 102 receives input of a name) and query (e.g., via networking circuitry 107) external 204 and/or internal data sources 205 regarding information associated with the selected person. Although the present disclosure will be described in the context of acquiring information from both internal data source(s) or external data source(s), it will be understood that all necessary information may be acquired from only internal or external sources in different embodiments. Further, although certain information may be described herein as originating from either an internal or external source, it will be understood that any information type may originate from either an internal or external source based on the configuration of the respective data sources and required information.

The evaluation system 202 may operate using a risk score methodology framework. The external data source(s) may access data associated with determined risk categories 206 (e.g., scores, rankings, transactions, etc.) and output a risk score for each particular risk category 210 based on a respective weight 2018 associated with each risk category and the accessed data 206 (e.g., modifying a risk score based on a weight). In some embodiments, some or all of the weightings 208 may be stored at external data source such that the external data source can return the appropriate risk output score(s) (e.g., along with underling risk data and weightings), while in other embodiments some or all of the weightings 208 may be stored at the evaluation system or servers associated therewith. To the extent that weightings 208 are stored at the external data source(s) for evaluation, the evaluation system may update those weightings as described herein. Depending on where the weightings are stored and accessed, the risk scores 210 associated with the external data source(s) 204 may be calculated at the external data source(s), the evaluation system 202, or at combinations thereof.

The internal data source(s) 205 may derive information and output a risk score 211 for each respective risk category 207 in a similar manner as the external data source 204 as described above. The risk category output scores 210 and 211 associated with each risk category 206 and 207 from the external 204 and internal 205 data sources may then be combined to calculate a combined evaluation risk score 214. In some embodiments, each of a combined external data source score and a combined internal data source score may first be computed, and then combined to generate the combined evaluation risk score. In some embodiments, the combined external data source score and/or the combined internal data source score may be evaluated prior to determining the combined evaluation risk score. For example, if any of the category risk scores 210 or 211, or combined scores for external or internal data sources, fails to meet a criteria (e.g., comparison to a threshold), the underlying transaction may be immediately flagged such as to deny a transaction. In an embodiment, the combined external data source score and the combined internal data source score may be combined to calculate a combined customer evaluation risk score 214 based on respective weightings applied to the data sources. For example, the calculated combined external data source score may be calculated to be 99 with a 20% combination weight and the calculated combined internal data source score may be 94 with an 80% combination weight. Based on these calculated combined scores and respective weights, the calculated combined evaluation risk score for “John Smith” is 95.

In some embodiments, control circuitry 104 may collate, calculate, and store the combined customer evaluation risk score described above. The calculated combined evaluation risk score may then be displayed on the user interface (e.g., via I/O circuitry 102) of the evaluation system 215. An exemplary user interface displaying the security results is shown in 216. Related persons connected to the customer may also be derived from risk category scores, as described above, that produce the combined risk score for the related person 218. The risk score of the specified searched customer 217 may be displayed simultaneously with the risk score of the related persons 218.

Each risk factor may be grouped into a category. For example, the risk factor categories 206 and 207 may include Geographic Risk, Industry Risk, Licenses Risk, Combined Person Data, and other risk factors such as customer activity, suspicious activity, cash-intensive activities, customer risk factors, travel records, national security flags, aliases, etc.

The user interface of the evaluation system may include settings that allow weights 208 and 209 to be selected for each factor against the other factors in each category 206 and 207. Allowing weights to be selected may enable the evaluation system to calculate a category risk output score 210 and 211. For example, the evaluation system may produce a weighted average associated with a category with the weights defined in user interface settings display page. The categories may be used to produce a single customer score via a weighted average.

In some embodiments, the risk factor categories may determine the weights. For example, if heavy weights are assigned to a category the evaluation system may determine that that category is more important than other categories. The weights may also be predetermined by the evaluation system.

The user interface may prompt the user to decide if the transaction is approved or rejected 220. In another approach, the user interface may provide a suggestion to the user to approve or deny a transaction. The user interface may be used to override the suggestion.

In another approach, the system may automatically approve or reject a transaction based on a threshold. For example, if a combined evaluation score of a selected person exceeds 80, the system may automatically reject a transaction.

The user interface of the evaluation system may display the assessment score results of the selected person 217. The user interface may display results of the selected person as a profile 216 to centrally manage information on each customer. The information contained in the profile may include customer number, TIN, date of birth, address, related persons information, etc.

The user interface provided by the evaluation system may maintain all relevant notes and commentary on customers in a centralized place 219. The user interface provided by the evaluation system may maintain documents on each customer to automate reminders for updating documents. In some embodiments, the user interface provided by the evaluation system may provide user activity tracking and audit logs. The user interface may show risk events on each customer. In some embodiments, the user interface of the evaluation system may include systems for storing and user interfaces for customer Profiles, Relationship Mapping, Automated Know-Your-Customer Research, Document Management, Watchlist Screening Legal 314(b) Communications, Risk Assessment Tool, anti money-laundering (AML) Laws/Regulations Library, Case Management and Transactions Analysis tools.

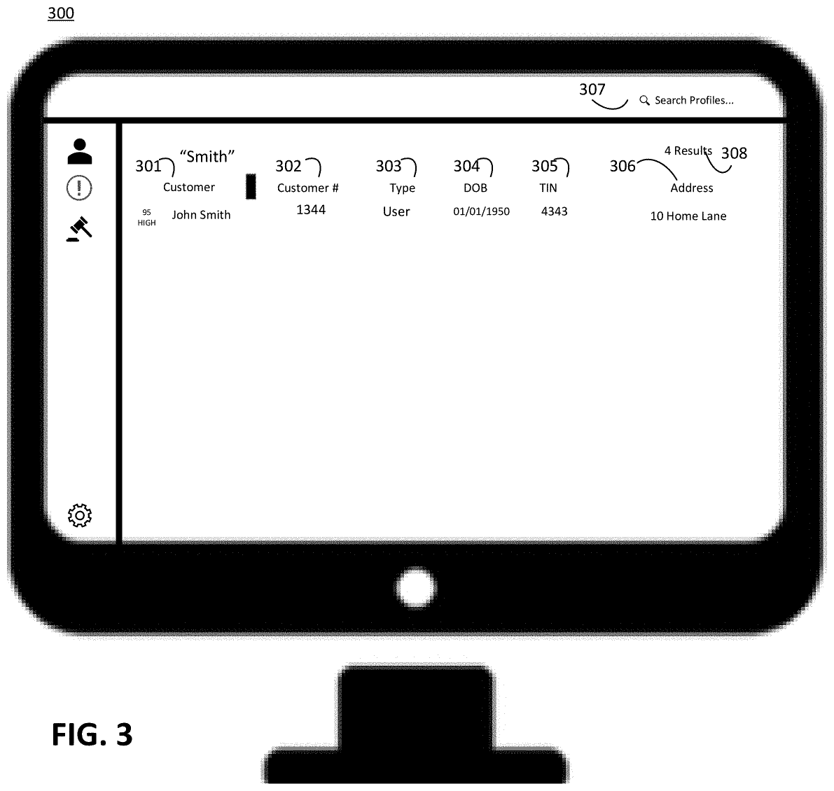

FIG. 3 depicts an exemplary user interface 300 of the evaluation system (e.g., evaluation system 101) displaying a selected persons profile generated by control circuitry 104 and networking circuitry 107. An exemplary user interface 300 may display information such as customer name and associated evaluation score 301, customer number 302, customer type 303, customer date of birth 304, customer's TIN 305, customer's address 306, etc. For example, as shown, the request to search for “Smith” is received by the user interface via, e.g., I/O circuitry. “John Smith” has been selected to be evaluated after the user interface has searched for the name “Smith”. The exemplary user interface may include a search bar to search for customer profiles 307. The exemplary user interface may include a visual representation of the number of results for the searched name 308. The visual representation of the number of results for the searched name 308 may be expanded and may include links to the related profiles. FIG. 3 further depicts an exemplary user interface that may be displayed at step 215 in FIG. 2.

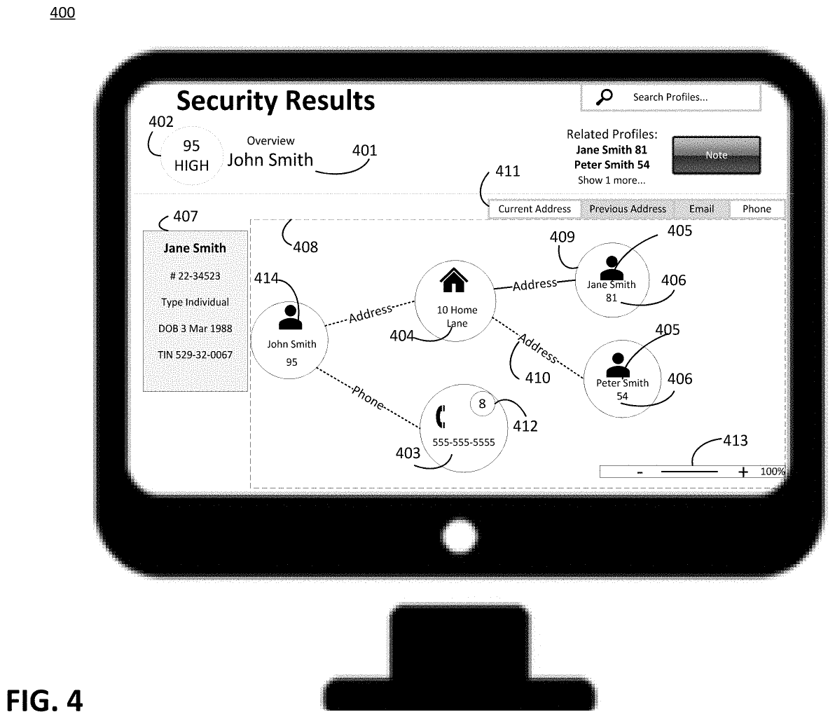

FIG. 4 depicts an exemplary user interface display screen 400 of the evaluation system displaying an information mapping tool. The user interface may display the combined score 402 for the selected person 401 (e.g., John Smith). FIG. 4 further provides another exemplary illustration of the user interface displaying the security results as shown in 216 in FIG. 2. The user interface may include the selected person's name 401 of John Smith next to his score 402 (calculated as described herein). The user interface 400 may also include the selected person's name 401 (e.g., John Smith) and associated risk score 402 in a graphical view 408. The user interface 400 may also show a variety of information related to the selected person (e.g., phone number 403, address 404, related people 405, etc.). The user interface may show the names of people associated with the selected person, John Smith 405 (e.g., Jane Smith, Peter Smith, etc.). The respective combined scores, calculated by the steps described in FIG. 2, may also be shown for each of these associated people 406. The user interface may display additional detailed information associated with a selected related person 407 (e.g., Jane Smith's phone number, type of customer, date of birth, TIN, etc.).

The exemplary user interface 400 may include a graph of relationships between the selected person and the additional people 408. Control circuitry 104 may provide the graph via the I/O circuitry to the output devices 103 between the selected person and additional people 408 based on the information collated by the networking circuitry 107. For example, the networking circuitry 107 may collect data associating additional people connected to John Smith via a shared address “10 Home Lane”. In some embodiments, the graph may include combined scores 406 for each person.

While the display of the relationship mapping 408 is shown as a Neo4J graph, relationship mapping may be provided as other display mapping tools to display the relationship between the selected person and related persons. The improved display of relationships may allow the user interface to identify connections between customers and determine material relationships. When the system determines a relationship is material, the relationship may be added to the related profiles in a portion of the user interface which gives a quick reference to help monitor customers in groups.

The user interface 400 provided by the evaluation system may add transactions between customers and mapping out additional data points like suspicious activity reports (SAR) filed and other important data connecting customers. This data may be used to calculate the assessment score as described herein (e.g., as one of the factors or categories).

The user interface 400 may include a plurality of data. The data contained in nodes 409 of the graph 408 may include information such as customer name, customer number, type of customer [individual/organization], date of birth, TIN, data contained in edges (lines linking the nodes), current address, previous address, email, phone number, etc. The nodes 409 may have large icons 414 to further help identify the type of connection and the edge type may be listed along the side of the edge 410 (e.g., John Smith is connected to Peter Smith by a common address).

The user interface 400 may include filters on a page to select types of relationships to filter 411. The filters may include current address, previous address, email, phone, affiliation, etc. The user interface 400 may include indicators 412 on nodes if there are additional connections to expand (e.g., small circle in top right of node showing the number of connections. There are “8” other connections to the phone number node of John Smith). The user interface 400 may include a menu showing a variety of view options, such as options to expand nodes, (edge types and number of nodes), allow nodes 409 to be collapsed, the ability to add individual/business nodes to related profile at a portion of the user interface of the customer profile, etc.

The user interface 400 may include auto zoom/expand when nodes 409 are expanded or collapsed. The user interface may include manual zoom/expand buttons 413 for manual adjustments. If the user interface changes anything on the display (expands nodes, filters, etc.) the display may revert back to default view. The interface may include icons 414 identifying the type of node (e.g., phone, email, address). The categories associated with the related people (e.g., address, phone, DOB, etc.) may each have a weight that influences the final combined assessment score of the related person 406 and the selected person 402. The weights may be pre-set or customized by the user. For example, as shown on display screen 400, Peter Smith is connected to John Smith by a similar address which may be a heavily weighted risk factor category that influences the calculation (e.g., calculated via the control circuitry 104) of the final combined assessment score of John Smith (e.g., John Smith's final combined assessment score is 95). In some embodiments, the visual depiction of the related persons and information may be selectable to allow a user to select which persons or relationships to attribute to the person under evaluation (e.g., to be included within the combined score).

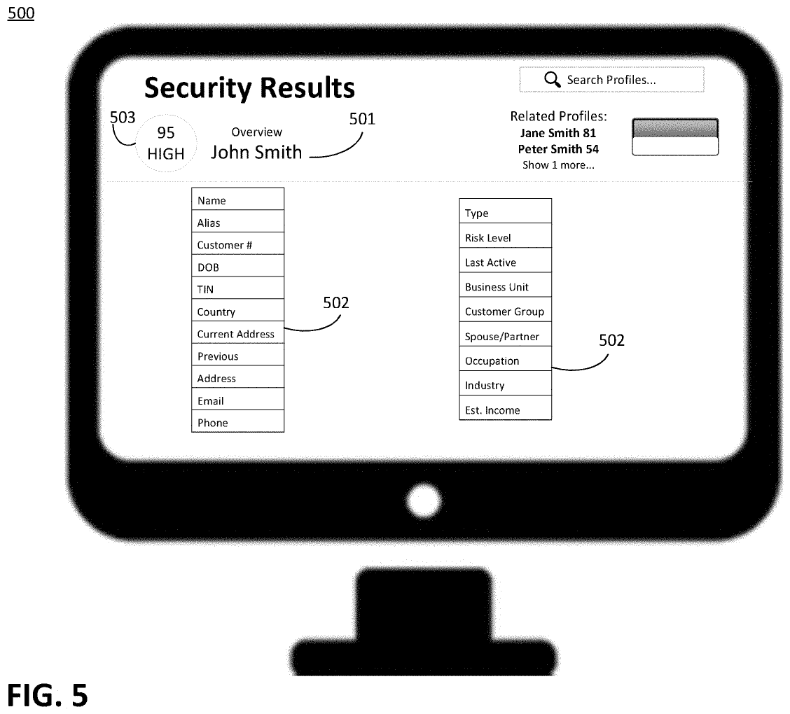

FIG. 5 depicts an exemplary user interface of the evaluation system displaying a selected persons profile 500 (e.g., the user interface displays the profile of “John Smith”). FIG. 5 further depicts an exemplary user interface that may be displayed at step 215 in FIG. 2. The user interface may generate and store customer profiles 501 via control circuitry 104. The evaluation system may have a profile for each customer aggregating all information on each customer in one place 501. The user interface 500 may display a page that is arranged with key info along with essential links in a table display 502 on the user interface 501 or by other means of display such as a series of tabs. User interface information may include: customer name, status (e.g., customer status—active, inactive, banned), industry, customer group, related profiles, notes, etc. 502. The user information may also include a combined score with indications such as high, medium, or low near the selected person's name 503. Other indications may include a color associated with the combined score such as red, yellow, and green depending on the score threshold.

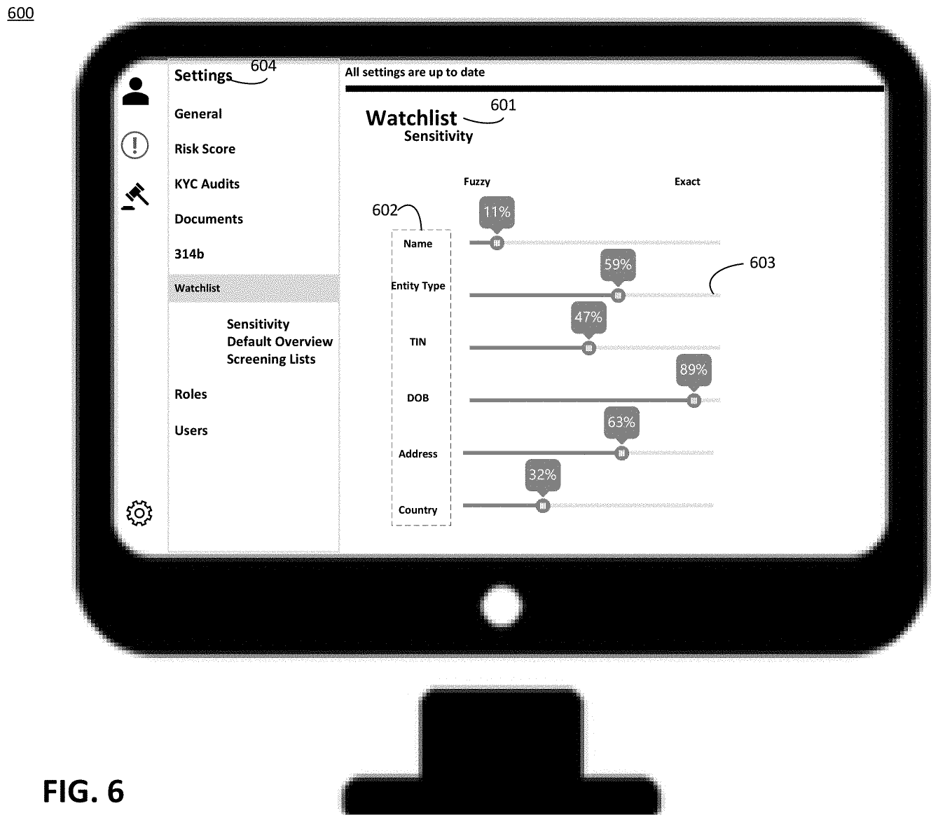

FIG. 6 depicts an exemplary user interface 600 of the evaluation system displaying a customer profile settings display screen that allows risk factor parameters to be customizable. For example, the “Watchlist” sensitivity factor 601 is to be changed. The user interface may provide a display to adjust the sensitivity of each of the sub-factors 602 (e.g., name, entity type, TIN, DOB, address, country) associated with the category factor 601. The user interface 600 may provide a display to adjust the sensitivity of each sub-category by a sliding scale 603 or by any other forms of changing the sensitivity (e.g., the user interface receives a specific number “30” to adjust the respective weight). This customer profile settings display screen may be found in the corresponding tab under the customer profile setting 604. FIG. 6 further depicts an exemplary user interface that may be displayed at step 215 in FIG. 2.

In some embodiments the user interface provided by the evaluation system may include questionnaires that allow the user interface to customize and add questions, risk score the information, and risk score the organization. The user interface may provide reporting and insights to help facilitate the risk assessment process. The user interface provided by the evaluation system may track changes that might impact the risk assessment and may provide notifications when the evaluation system recommends they update the risk assessment based on the laws/regulations that may be monitored.

FIG. 6 further depicts additional categories that may be displayed on the user interface provided by the evaluation system that may be present under the customer profile tab 604. For example, the user interface provided by the evaluation system may include a docket management tool. The evaluation system may allow the user interface to deploy a portal to customers so they can login and submit document requests, fill-out forms, etc. The document management tool may allow the user interface to manage a plurality of documents for each customer (e.g., using networking circuitry 107. The evaluation system may provide a document repository on each customer.) The document management tool may deploy a portal to their customers to allow the customer to login and submit document requests, fill-out forms, etc.

The user interface provided by the evaluation category may include a transactions analysis and alerts tool category. The evaluation system may import customer transactions from the users of the systems. The evaluation system may use algorithms and machine learning to analyze transactions for suspicious activity and produce notifications when suspicious activity is identified.

In some embodiments, the user interface provided by the evaluation system may include a vendor risk management tool. The user interface may be able to interact with vendors through a portal, send requests (documents, forms, etc.) and the vendors can fulfil those requests. The user interface of the evaluation system may perform due diligence research into vendors, scan them against watchlists, and centrally manage their vendor risk similar to how the tool for customer risk is used as described herein.

In some embodiments, the evaluation system may include a government investigations tool. The evaluation system may adapt the vendor risk management software to assist government officials and regulators who regulate specific businesses such as a marijuana control board. The due diligence tool may be a monitoring, investigating, and researching tool for government officials and regulators.

In some embodiments, the user interface provided by the evaluation system may include an automated license monitoring tool that may store data related to a plurality of licenses related to a customer (e.g., cannabis licenses, firearms licenses, etc.). The evaluation system may aggregate (e.g., via networking circuitry 107) publicly available licenses for certain high-risk industries and display the license status on customer profiles. The user interface may provide notifications if a license status changes.

In some embodiments, the user interface provided by the evaluation system may include a case management tool that may include suspicious activity reports (SAR) and templates for reporting. The case management tool may track recurring cases by using case data to populate SAR reports. In some embodiments, the evaluation system may include machine learning capability for automating workflows for creating alerts, preparing SAR reports, and identifying suspect transactions.

In some embodiments, the user interface provided by the evaluation system may include a risk assessment tool. The assessment tool may be used for risk assessments outside of anti-money laundering (AML) like U.S. sanctions, fraud, and other purposes. The risk assessment tool may use gaming risk data, blockchain risk assessment, parent/child risk data (e.g., collated by the networking circuitry 107) to create a risk assessment scores on an annual and/or continuous basis to manage related tasks and generate reports.

In some embodiments, the user interface provided by the evaluation system may include a transaction analysis tool. The transaction analysis tool may allow the user interface to import customer transactions. The transaction analysis tool may display transactions, analyze transactions and suspicious activity, and create appropriate alerts. The transaction analysis tool may use algorithms and machine learning to analyze transactions for suspicious activity and produce notifications for the user interface when suspicious activity is identified.

In some embodiments, the user interface provided by the evaluation system may include a know your customer (KYC) audits tool. The KYC audit may be a background check tailored for financial crime risk management. The user interface may allow audits to be created for a plurality of people/businesses at a single time. The KYC tool may automate searches of public records. The user interface may then provide a report that combines all of the information for display.

In some embodiments, the user interface provided by the evaluation system may include an events tool. For example, report/store risk events such as a customer leaving drugs in their hotel room, getting arrested, and being involved in the news may want to be reported. The events tool may allow the user interface to store these events.

In some embodiments, the user interface provided by the evaluation system may include an ability to input data on customer user-defined fields and an ability to input data on SAR and other reports.

In some embodiments, the user interface provided by the evaluation system may include a vendor risk management tool. The vendor risk management tool may interact with vendors through a portal, send requests (documents, forms, etc.) and the vendors can fulfil those requests.

In some embodiments, the user interface of the evaluation system may include a government investigations tool. The evaluation system may adapt the vendor risk management software described above to assist government officials and regulators who oversee and regulate specific businesses such as a marijuana control board. The vendor due diligence tool may be adapted to provide monitoring, investigations, and a research tool for government officials and regulators.

In some embodiments, the user interface provided by the evaluation system may include a knowledgebase tool. The evaluation system may maintain a user-only accessible website with a knowledgebase, helpdesk ticketing, and a forum for keeping users updated on upcoming software releases with the ability for the user to communicate feedback. The knowledgebase may be a “user's manual” for how the software works and provide in-depth trainings on specific items of interest to clients.

In some embodiments, the user interface provided by the evaluation system may include a custom upload for screening tool. The customer upload tool may be used to screen persons or businesses against customer lists. The customer lists may be a special government list and/or a generated list.

In some embodiments, the user interface provided by the evaluation system may include a Watchlist Matching tool. The Watchlist Matching tool may be used to match information on a specific person or organization to users generated profiles.

In some embodiments, the user interface provided by the evaluation system may include Bad Actors tool. The Bad Actors tool may be used to identify individuals and/or organizations included in the Watchlist Matching tool. A profile may be created for each individual and/or organization identified. The profile may then rematch against the customer profiles in the evaluation system.

In some embodiments, the user interface provided by the evaluation system may include a Legal Module tool. The Legal Module tool of the evaluation system may aggregate the annual anti-money laundering (AML) index report from the Basel Group and other public sources on Government, which may assign each country a risk score on AML risk. The evaluation system may display this information in an interactive graphic. Users may have the capability to click on a country and legal module tool may summarize the information for the user from the Basel Report and other publicly available sources. The evaluation system risk may rate countries based on categories such as secrecy, terrorist financing, smuggling, etc. In addition, this toll may provide a document library of all AML-related laws and regulations in every country in the world and insights our team extracts from this data including trends in laws/regulations, enforcement actions, a client's exposure to countries via customers or vendors, and their controls.

In some embodiments, the user interface of the evaluation system may include a machine learning tool. The evaluation system may use the machine learning tool to automate work typically completed by users (e.g., decisioning watchlist matches, decisioning suspicious transaction alerts, decisioning opening cases, etc.). The machine learning tool may also automate identifying suspicious transactions based on such information as patterns of activity, connections between high-risk parties or other material relationships, etc.

In some embodiments, the user interface of the evaluation system may include a network intelligence tool. The network intelligence tool may use publicly available information on government watchlists which may be downloaded and used build out the personal and professional networks of individuals and entities on the watchlist. This information may then be examined against customers in the evaluation system to identify relationships. For example, the evaluation system identifies the board memberships of a sanctioned individual using corporate records 2-3 tiers out. This information can then be examined against an entity's customers in the evaluation system's data source. The evaluation system identifies a customer, for example, that serves on a board of a company wholly owned by a sanctioned party. The evaluation system maps out similar networks in high-risk industries like Cannabis as well to show all the businesses a person owns or is affiliated with who is also affiliated to a cannabis business. This enables the user interface, for example, to display: customer John Smith is an executive of a real estate business, but also serves on the board of a cannabis business.

In some embodiments, the user interface provided by the evaluation system may include a link assignment tool. The link assignment tool may allow the user interface to search for users of the evaluation system and assign them to the watchlist alerts automatically. The evaluation system may auto-populate the comment boxes for the buttons (positive, possible, and false) with standard language plus the fields that matched. For example, the comment boxes may auto populate that the match is based on name, DOB, and country, possible match based on Name, DOB, and Country, or false match based on [leave blank so manual assertion on why it's a false match].

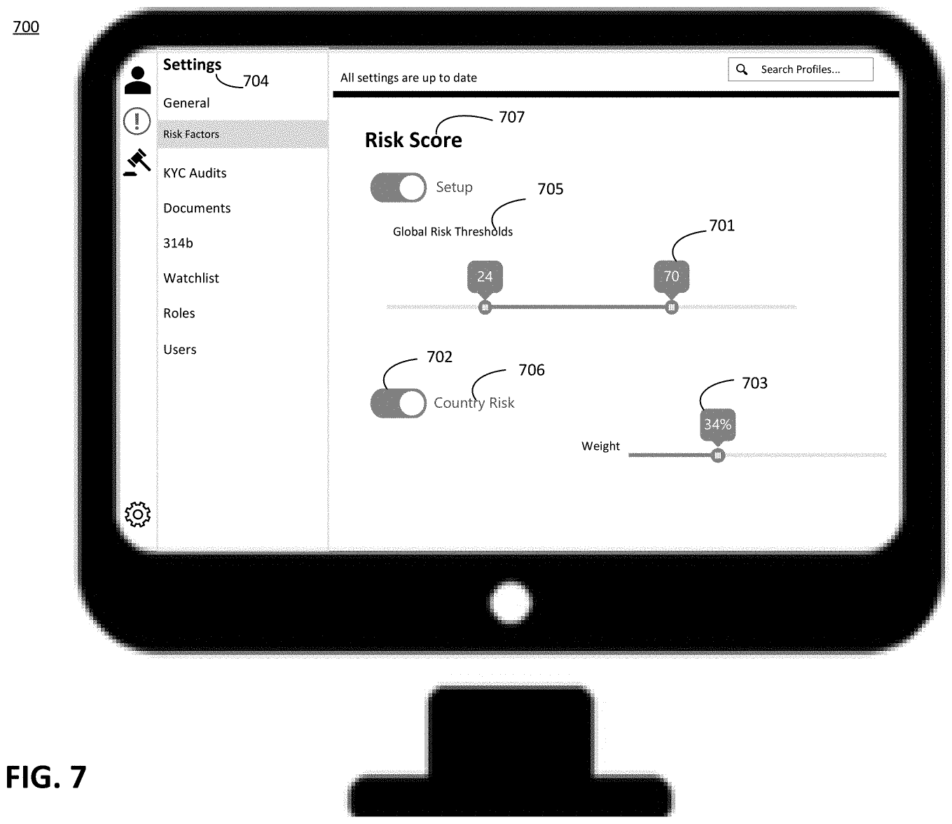

FIG. 7 depicts an exemplary user interface 700 provided by the evaluation system that may include a risk score tool 707. The evaluation system may produce a risk score for each customer profile. The risk score may be based on a number of factors (e.g., global risk thresholds 705 and country risk 706). These factors may be turned on/off 702. Allowing weights to be selected may affect the calculation of a category risk output score 210 and 211 of FIG. 2. The user may be able to select the weight of each factor 703. The weights may be used to create a category score. The categorical scores may then be used to produce the combined score. For example, if the “Country Risk” score is turned “off” the evaluation system may weigh other category risk factors more heavily when calculating the combined evaluation risk score 214. This process may be displayed on the Risk Factor Tab of the customer profile setting 704. FIG. 7 further depicts an exemplary user interface that may be displayed at step 215 in FIG. 2.

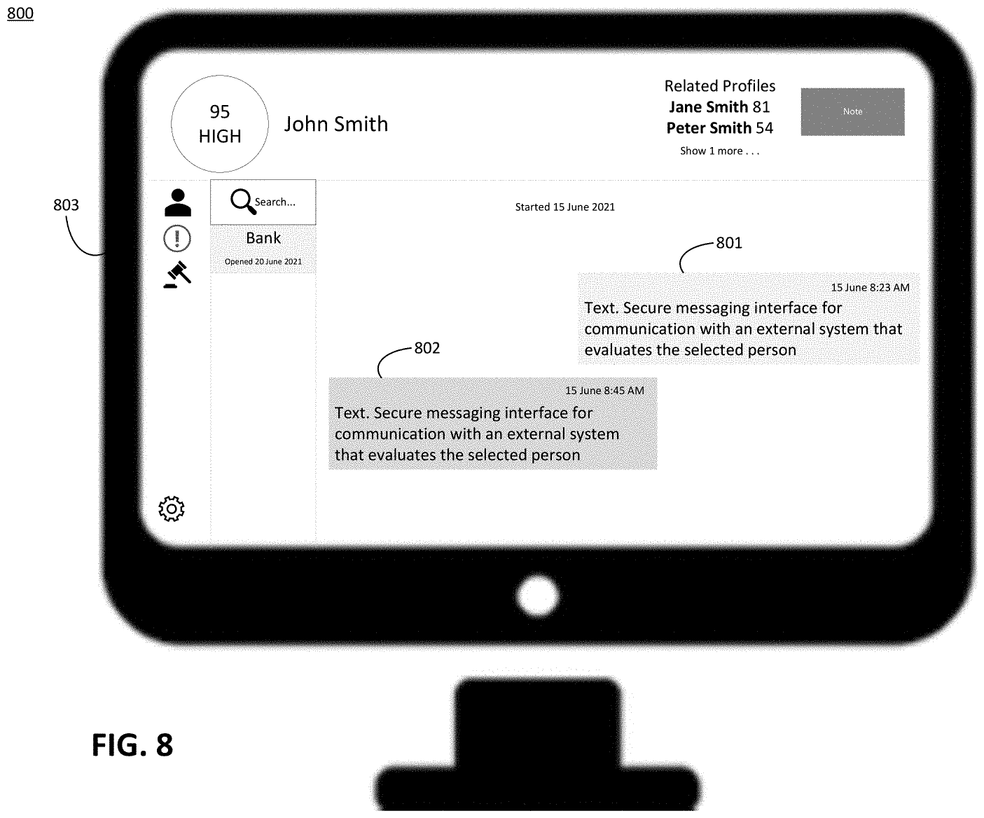

FIG. 8 depicts the user interface 800 provided by the evaluation system which may include an improved communication interface 803 for enabling secure transfer of information. FIG. 8 further depicts an exemplary user interface that may be displayed at step 215 in FIG. 2.

The communication interface 803 may be a 314b communications tool. 314b is a provision of the US Patriot Act (section 314 sub-part b) that allows organizations to communicate with one another about customers whom they suspect are involved in money laundering, terrorist financing, and other financial crimes activities.

To facilitate these communications, the user interface provided by the evaluation system may include an encrypted communications tool. The secure messaging interface may be used for communication with an external system (e.g., external evaluation system 110 of FIG. 1) that may evaluate the selected person. Such messages may be received via secure messaging interface 803 and transmitted to the external system in an encrypted form (e.g., messages are received and transmitted to the external system 110 in an encrypted form 111). If the other system is a similar evaluation system, the messages may appear in a similar interface 802. Otherwise, the messages may be sent via encrypted email. In addition, if encrypted email messages are received, they may be decrypted and shown via the secure messaging interface 803.

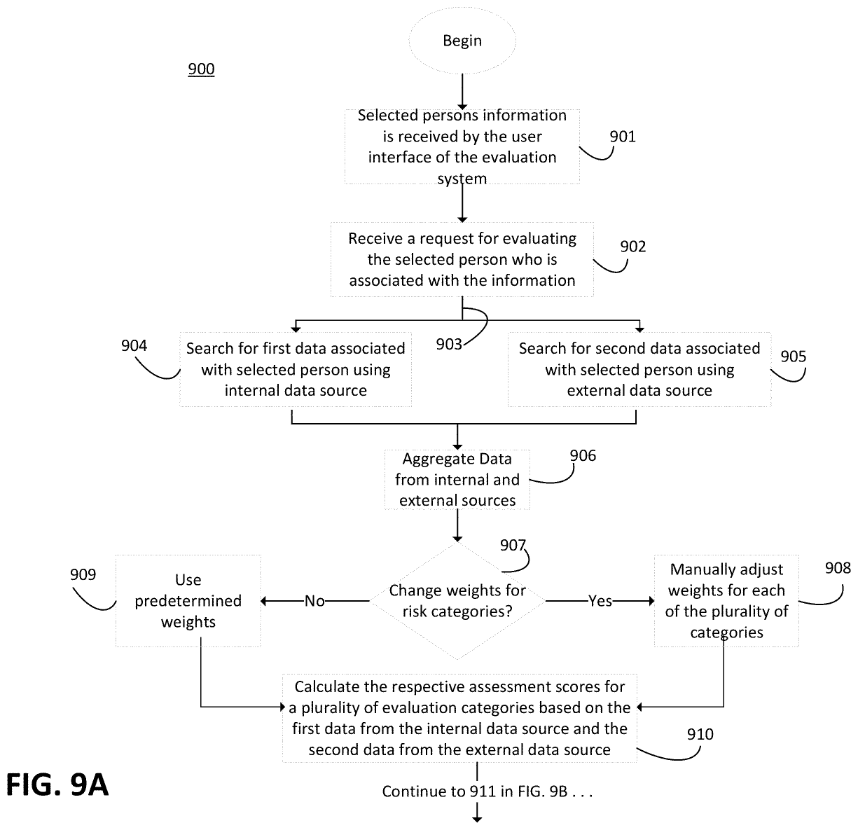

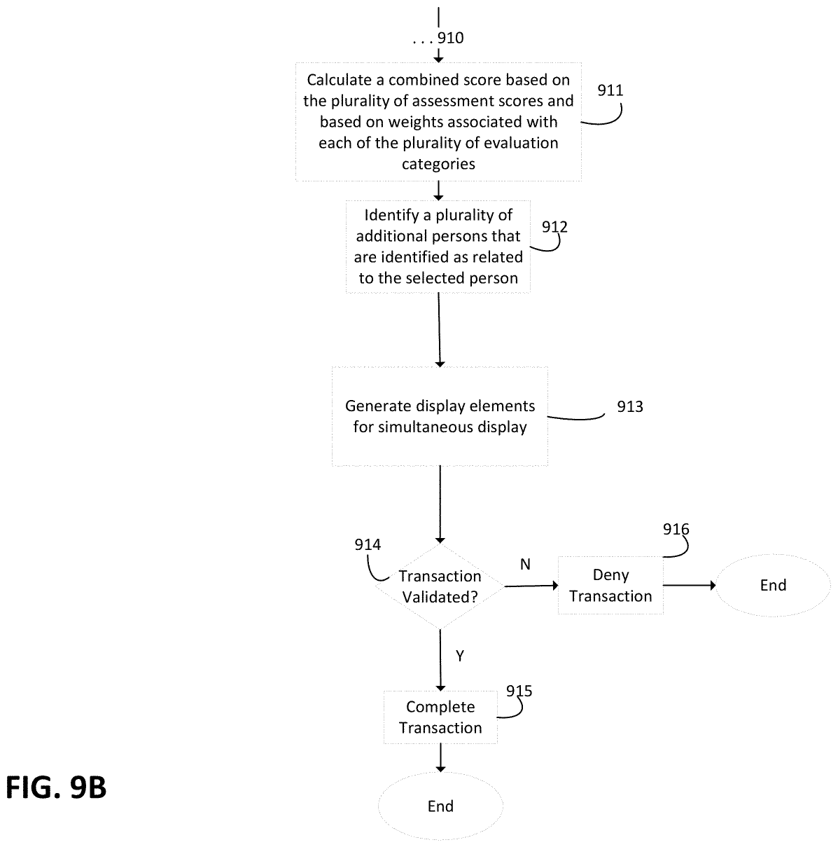

FIGS. 9A and 9B present a flowchart 900 of illustrative steps for computing an evaluation score with the evaluation system and for displaying such scores with the improved user interface. It should be noted that the steps of flowchart 900 can be performed by control circuitry 104, networking circuitry 107, and I/O circuitry 102 of FIG. 1. Control circuitry 104, networking circuitry 107, and I/O circuitry 102 may be part of a device having a display 103 (e.g., a device that may have any or all of the functionality of a user computer equipment with a display screen 300 of FIG. 3).

At step 901 the evaluation process of the selected person begins by the user interface receiving information about the selected person (e.g., the user interface receives selected persons information at I/O circuitry 102 in FIG. 1).

At step 902, the user interface provided by the evaluation system receives a request for evaluating the selected person who is associated with the information (e.g., via I/O circuitry 102).

At step 903, the evaluation system (e.g., evaluation system 101) searches for first data associated with the selected person using an internal data source 904 and/or an external data source 905 (e.g., via networking circuitry 107). Although searching via both internal and external data sources is depicted in FIG. 9A, it will be understood that data acquisition may be performed from only internal or external data sources as appropriate and as described herein.

At step 906, the evaluation system (e.g., evaluation system 101) aggregates the data from the internal and external sources (e.g., via control circuitry 104). In some embodiments, as depicted in FIG. 9A, the raw obtained data is obtained from the internal and external data sources for aggregation and prior to calculation of combined scores. It will be understood, in accordance with the present disclosure, that this aggregation may be performed at other stages of the data processing, for example, after weightings are applied and/or combined scores are calculated, depending on system configuration(s).

At step 907, the user interface presents the option to change the weights associated with each of the plurality of evaluation categories associated with the external and internal data (e.g., via the control circuitry 104). If the user interface wishes to change the weights associated with each of the plurality of evaluation categories, the user interface may proceed to step 908 to adjust the weights as desired; if the user interface is satisfied with the predetermined weights the user interface may proceed to step 909. It will be understood that in some embodiments changing of the weights may be performed in a separate process that is not within the flow depicted in FIGS. 9A and 9B.

At step 910, the evaluation system (e.g., evaluation system 101) calculates a plurality of assessment scores for a plurality of evaluation categories based on the first data from the internal data source and the second data from the external data source (e.g., via control circuitry 104).

At step 911, the evaluation system (e.g., evaluation system 101) calculates a combined score based on the plurality of assessment scores and based on weights associated with each of the plurality of evaluation categories (e.g., via control circuitry 104).

At step 912, the evaluation system (e.g., evaluation system 101) identifies a plurality of additional persons that are identified as related to the selected person (e.g., via control circuitry 104).

At step 913, the evaluation system (e.g. evaluation system 101) generates items for simultaneous display on the user interface (e.g., via I/O circuitry 102). Although a variety of suitable display elements may be generated and displayed in accordance with the present disclosure, as an example, the following elements may be generated for simultaneous display: (a) an identifier of the selected person; (b) a visual representation of the calculated combined score associated with the selected person; (c) identifiers for each of the plurality of additional persons; and (d) a visual representation of each of the additional combined scores associated with each of the plurality of additional person, and wherein the combined score not exceeding a threshold causes the information for the selected person to be validated.

At step 914, the evaluation system determines whether the transaction is valid. As described herein, such validation may be performed by a user (e.g., based on an evaluation of the displayed information), automatically by the system, or may be based on a combined validation (e.g., via a recommendation provided by the system for user confirmation). If the transaction is to be accepted, the processing may proceed to step 915. If the transaction is to be denied, processing may proceed to step 916.

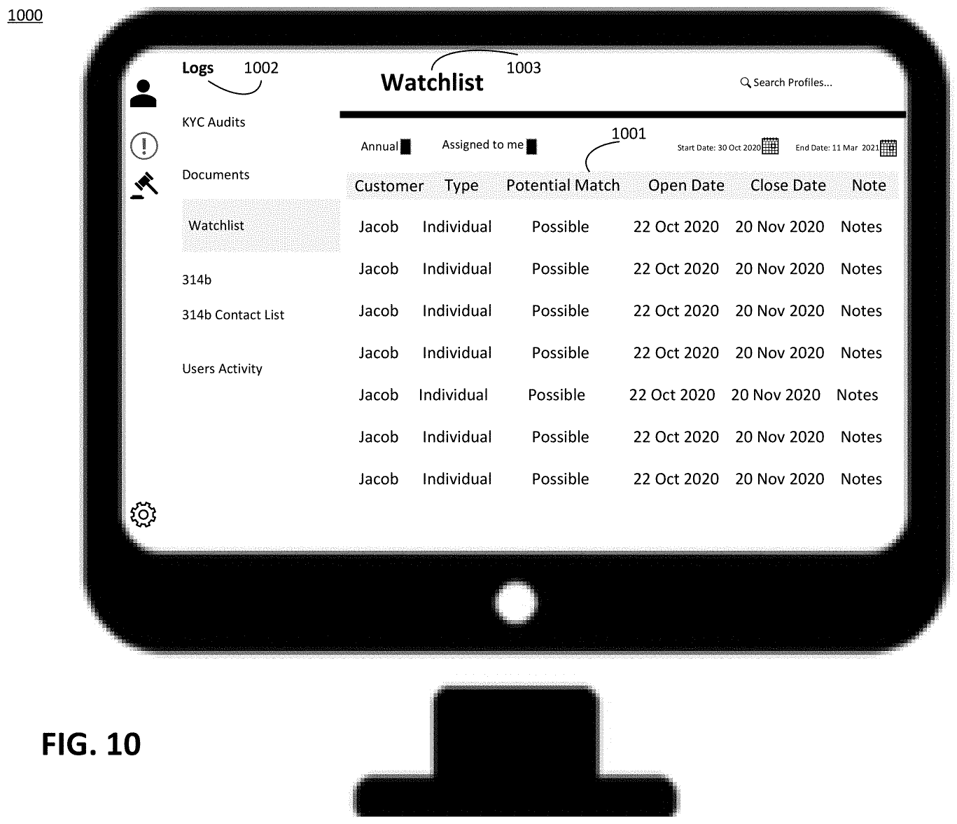

FIG. 10 depicts an improved user interface 1000 of the evaluation system displaying an activity log 1002. All activity may be tracked in the activity log 1002 of the evaluation system. FIG. 10 further depicts an exemplary user interface that may be displayed at step 215 in FIG. 2.

FIG. 10 further depicts an exemplary improved activity log 1002 of the user interface provided by the evaluation system that may include a Watchlist Screening tool 1003. The watchlist screening tool may be used to decide if the potential matches aggregated by the data from internal and external data sources are true (positive) matches, possible, or false matches. This watchlist screening tool may enable the user interface to identify any individual and/or organization on a watchlist. The user interface may provide a side-by-side comparison of the customer data, potential match data, highlights what the evaluation systems determined to be matches, and then provides additional information across a series of tabs 1001 to help the user evaluate the data. The evaluation system may have an ability to assign multiple potential matches, the ability to resolve multiple potential matches (positive, possible, false with comment), and/or the ability to reopen multiple potential matches.

In some embodiments, the evaluation system may perform Watchlist Potential Match Scoring. For example, each potential match may be scored based on the likelihood of a positive match on a 0-100 scale. In another example, an SSN match will carry a higher weight than a name match. Some combinations may be associated with a high likelihood of a match and some combinations are associated with a lower likelihood. For example, name, DOB, and street address is higher likelihood than name, DOB, and country. This risk score may appear just as all other scores—color coded, green, yellow, and red with a ring around it. It may appear in the left pane and in any portion of the user interface.

In some embodiments, the user interface provided by the evaluation system may include a Watchlist Quick Screen. The Watchlist Quick Screen may allow compliance professionals to conduct one-off searches of non-customers to ensure they are not prohibited parties when conducting one-off transactions or taking new customers. The Watchlist Quick Screen may be used to allow users to insert true sanctioned individuals and/or companies to test the user interface provided by the evaluation system and/or adjust the sensitivity settings.

In some embodiments, the evaluation system may train an AI process (e.g., via supervised or unsupervised machine learning) to emulate a decision made by an analyst so it may make a decision to acknowledge the potential matches as True, Possible, or False. The evaluation system may include a feature for the user to verify they checked an alert for accuracy (e.g. a small button or icon) and a log or a verification column in the existing log. Users may also select the automated process to only process potential matches under a certain score.

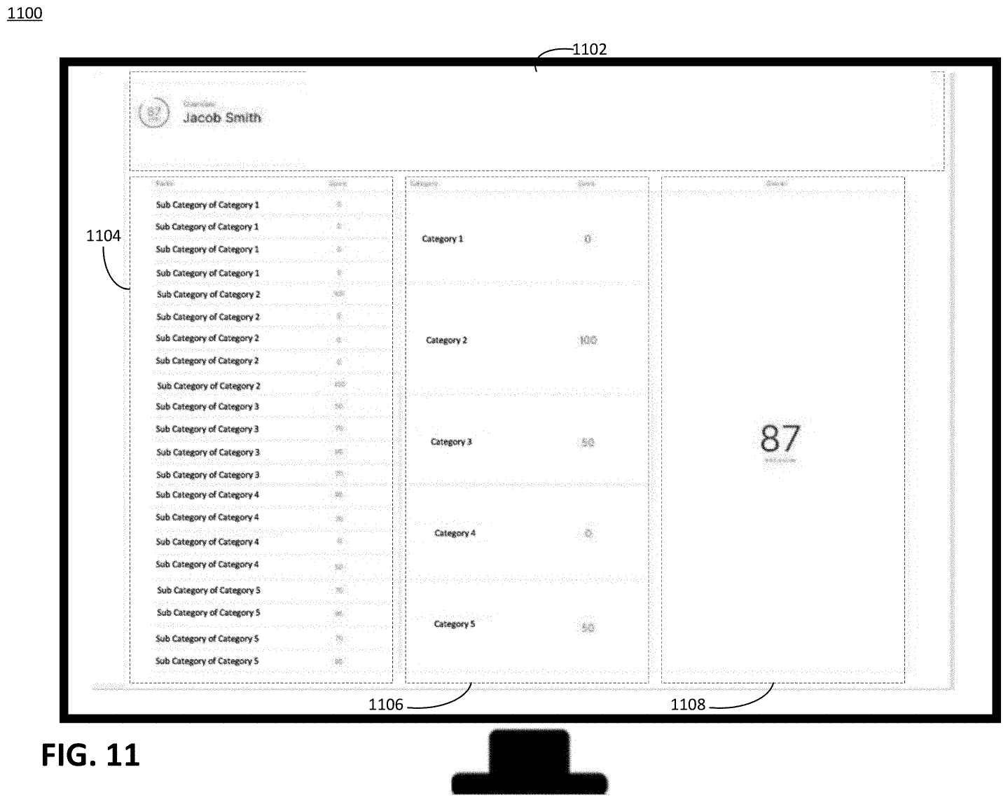

FIG. 11 depicts an improved user interface 1100 of the evaluation system displaying detailed risk categorizations. The information displayed in FIG. 11 may be displayed simultaneously, allowing for a user of the system to analyze related information in a simple and intuitive manner, thus enabling better decision making and reducing a number of display and processing steps required to take particular actions. Although other display components may be included in some embodiments, components may be removed (e.g., selected user display 1102 may be removed), or the relative position and orientation of display components may be modified in some embodiments, as shown in FIG. 11 an exemplary detailed risk categorization display 1100 may include a selected user display component 1102 along with detailed risk categorizations oriented in a waterfall fashion from left to right, including risk sub-categories display component 1104, risk categories display component 1106, and combined risk score display component 1108.

Selected user display portion 1102 includes information about a user, such as one or more identifiers (e.g., name, customer number, personal identifying information, etc.), status information (e.g., an indicator that the user is “Banned” and information such as status indicators describing the reason for the particular status), identification about related users (e.g., name and relationship to the related user), information about the related users (e.g., risk score of related user), combined risk score for the selected user, visual indicators (e.g., color coding or other emphasis for any of the other information of the selected user display portion 1102), or other suitable information related to a selected user as described herein. Providing this information with the detailed risk categorization information may provide an intuitive way to assess a user and the particular reasons for a status, and consider actions necessary to update or modify statuses, or perform other decision making.

Risk sub-categories display component 1104 is oriented at a far-left portion of the detailed risk categorization display and includes a number of risk sub-categories along with associated information such as scores. Additional indicators and/or emphasis may be provided related to the sub-categories and scores, such as color-coding, changes of emphasis (e.g. highlighting, font size, etc.), or icons. As depicted in FIG. 11, the risk sub-categories may each be associated with a respective risk category from risk categories display component, although in some embodiments a risk sub-category may be associated with multiple risk categories, or one or more risk sub-categories may not be associated with any risk categories (e.g., may not roll into any risk category score). Selecting one or more of the risk sub-categories may bring up information particularly to such sub-category, such as information to modify the manner of scoring for the risk category, to modify associations to categories, and other similar parameters.

Risk categories display component 1106 is oriented adjacent (e.g. to the right) of risk sub-categories display component 1104, although the relative location and orientation of these components may be provided in other manners that maintain the associations between sub-categories and categories. The risk categories display component includes risk categories and other information such as scores, although additional indicators and/or emphasis may be provided related to the sub-categories and scores, such as color-coding, changes of emphasis (e.g. highlighting, font size, etc.), or icons. Selecting a risk category may allow for information related to the risk category to be modified, such as the sub-categories that are provided as inputs to the category, weighting provided to particular characteristics, thresholds for particular actions, and display characteristics.

Combined risk score display component 1108 is oriented adjacent (e.g. to the right) of risk categories display component 1106, although the relative location and orientation of these components may be provided in other manners that maintain the association between the combined score and the underlying risk categories. The combined risk score provides the overall risk information for the selected user, combining the respective risk category scores (and in some embodiments, selected risk sub-categories) in accordance with a predetermined combination methodology (e.g., based automation of regulatory requirements, based on entity settings, etc.). Selecting the combined risk score component 1108 may allow for information related to the combined risk score to be modified, such as the categories that are provided as inputs to the score, weighting provided to particular categories, thresholds for particular actions, and display characteristics.

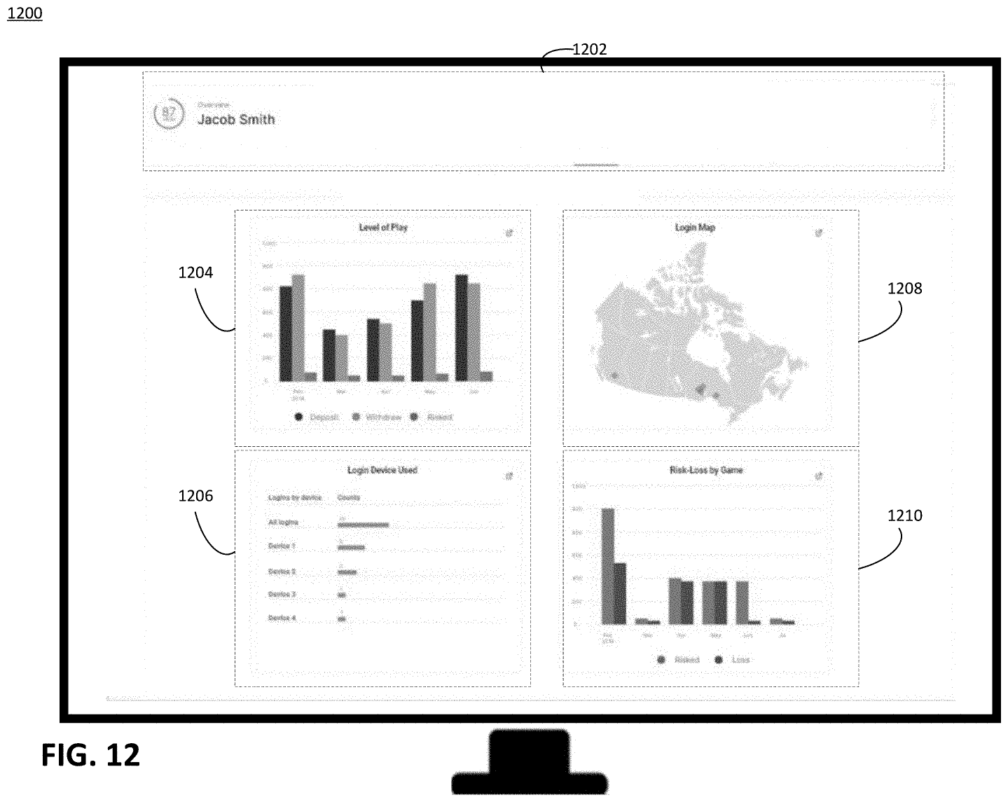

FIG. 12 depicts an improved user interface 1200 of the evaluation system displaying risk activity visualizations. The information displayed in FIG. 12 may be displayed simultaneously, allowing for a user of the system to analyze related information in a simple and intuitive manner, thus enabling better decision making and identification of activities that may otherwise fall outside of standard risk scoring metrics, allowing for actions to based on unique visualizations and combinations thereof that may not strictly violate a regulatory rule or similar criteria. Although other display components may be included in some embodiments, components may be removed (e.g., selected user display 1202 may be removed), or the relative position and orientation of display components may be modified in some embodiments, as shown in FIG. 12 exemplary risk activity visualizations 1200 may include a selected user display component 1202 (e.g., as described with respect to selected user display component 1102 in FIG. 11) along with specific visualizations oriented in a suitable fashion (e.g., a grid or other suitable display), including level of play display component 1204, device display component 1206, geographic display component 1208, and activity type display component 1210.

Level of play display component 1204 includes visualizations related to a level of play (or other similar activity) and provides a visualization of relevant metrics related to the volume, frequency, periodicity, timing, and other patterns of play engagement (e.g., based on amounts wagered or put at risk). The level of play component can provide a variety of suitable components that are broken out for viewing, such as deposits put in to play, withdraws of amounts removed from play and amounts risked. Moreover, such information may be provided on a variety of suitable scales, such as suitable time scales. Although a bar graph is depicted in FIG. 12, other suitable display types may be utilized. Portions of the display (e.g., transaction type, time scale, etc.) may be selected to modify aspects of the display, such as inputs, scale, addition of thresholds or alerts, etc.

Device display component 1206 includes visualizations related to a manner of play, which in the context of transactions monitored over a network may be via a variety of devices that are associated with a user (e.g., computers, tablets, smart phones, smart watches, AR/VR devices, vehicle infotainment systems, etc.) or that a user accesses (e.g., public computing devices, dedicated terminals, in-person activities monitored by sensors, etc.). The device display component 1206 provides a visualization of relevant metrics related to the volume, frequency, periodicity, timing, and other patterns of device usage (e.g., based on time of access, length of access, activities during access, etc.). The device display component 1206 can provide a variety of suitable components that are broken out for viewing, such as device identifiers, device types (e.g., by operating system, device manufacturer, etc.), and access method (e.g., browser, application, terminal, etc.). Moreover, such information may be provided on a variety of suitable scales, such as suitable time scales. Although bar graphs are depicted in FIG. 12, other suitable display types may be utilized. Portions of the display (e.g., device type, time scale, etc.) may be selected to modify aspects of the display, such as inputs, scale, addition of thresholds or alerts, etc.

Geographic display component 1208 includes visualizations related to the location where play is occurring. The geographic display component 1208 provides a manner of visually processing respective geographies, such as a scalable, movable map that provides indications of geographic locations where transaction have occurred. The indications may be displayed in a variety of manners, for example, with colors and indication size and/or intensity based on the characteristics of the transactions in the geography. The indications can be selectable or modifiable, so as to be based on different criteria such as type of transaction, amount or time thresholds, and the like. Selection of indications may also allow for tunneling down to detailed information regarding the specific transaction(s) in the geography, as described herein.

Activity type display component 1210 includes visualizations related to the activity type engaged in by the user, such as particular games engaged in by the user. For example, a user may engage in a variety of activity types such as different types of games, sports betting, other betting, and the like. Various metrics may be provided for the type of game, such as amount risked, amount lost, time played, variance in play, or other patterns of play. Selecting a particular game may provide detailed information about that game, including detailed (e.g., time-scaled) risk-loss tracking for the user. In some embodiments, a display may include a generic risk-loss display for a time period, which when selected may include information about the particular activities associated with the risk-loss display. Such information may be provided on a variety of suitable scales, such as suitable time scales. Although bar graphs are depicted in FIG. 12, other suitable display types may be utilized. Portions of the display (e.g., device type, time scale, etc.) may be selected to modify aspects of the display, such as inputs, scale, addition of thresholds or alerts, etc.

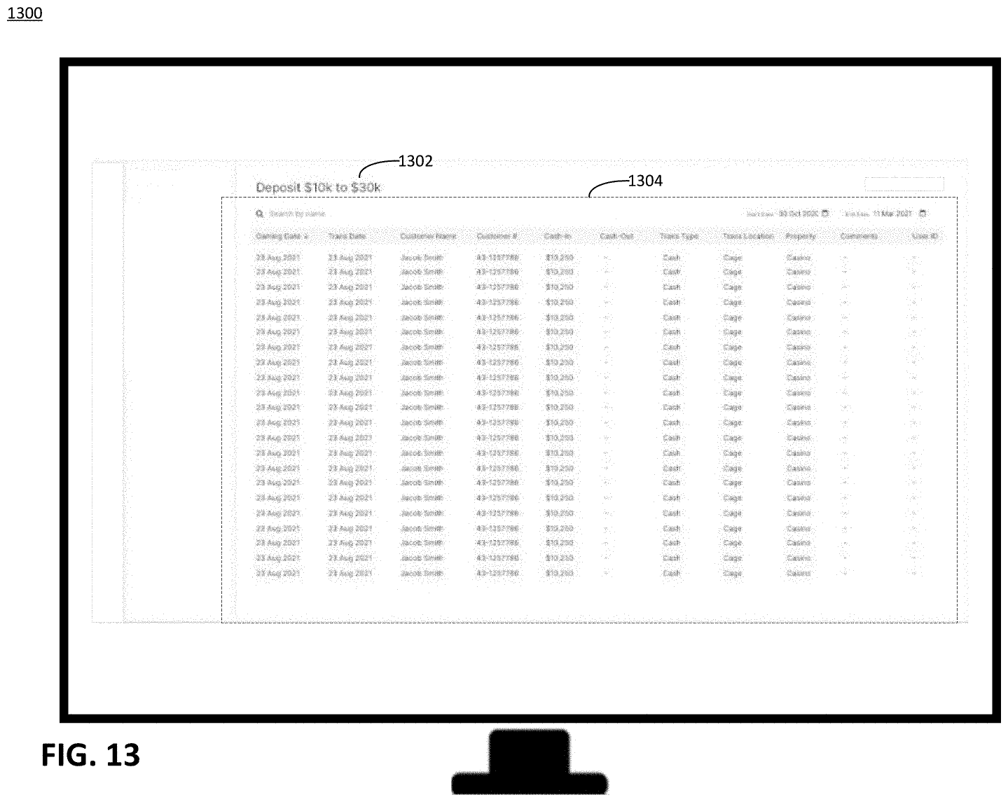

FIG. 13 depicts an improved user interface 1300 of the evaluation system displaying risk activity reporting. Exemplary risk activity reporting 1300 may include a reporting criteria 1302 and a reported information display component 1304, although other components may be added in other embodiments. As described herein, an entity utilizing the evaluation system may be subject to a variety of reporting requirements from a variety of entities and a variety of entity types (e.g., government, regulatory, industry, entity, enterprise, etc.). Understanding the information that must be reported, the reason for the reporting, and the manner of reporting may be challenging and confusing even for sophisticated entities. Accordingly the risk activity reporting provides an interface for understanding and navigating the various reporting that occurs within the evaluation system.

Reporting criteria 1302 depicts a selected reporting criteria that is being viewed within risk activity reporting 1302. The evaluation system may include a variety of reporting criteria, such that any individual reporting criteria may be accessible via interfaces associated with particular reports that are required (e.g., for particular audiences such as regulatory bodies, corporate level, etc.), interfaces that aggregate or categorize report types, common categories between reports, etc.

Reported information display component 1304 includes a display of reported information associated with the particular reporting criteria. Although depicted as a table with selectable and sortable columns, it will be understood that other depictions may (e.g., visual indicators with only key information) may be provided in other embodiments and that information may be prioritized or emphasized in a variety of suitable manners (e.g., highlighting, changing coloring or intensity, or other emphasis) such as to show reported transactions that are indicative of activity that may require further action. The reported information may include any suitable information as required for the particular recipient, such as transaction identifiers, customer identifiers, reporting entity, receiving entity, location, time, etc. Each reported item may be selectable to provide further information, allow for user action related to a reported action (e.g., commenting or approval override), or modification of the manner of display of reported items.

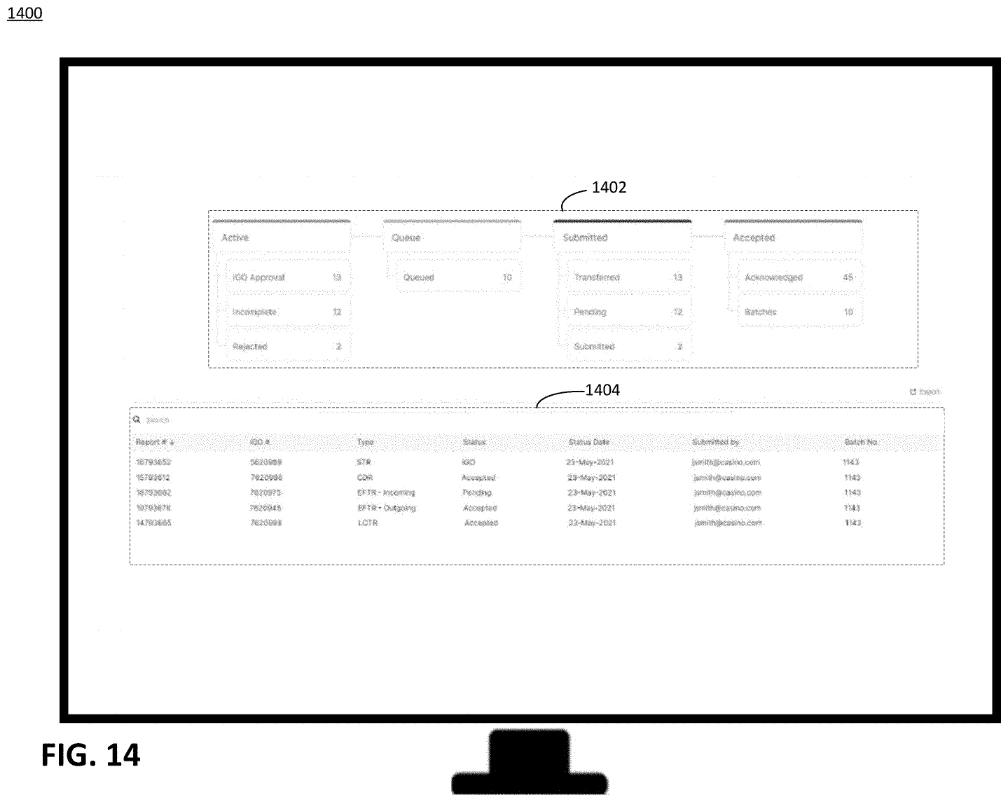

FIG. 14 depicts an improved user interface of the evaluation system including a reporting status display 1400. The reporting status display 1400 includes a reporting status visualization display component 1402 and a report details display component 1404, although other components may be added in other embodiments. As described herein, an entity utilizing the evaluation system may be subject to a variety of reporting requirements from a variety of entities and a variety of entity types (e.g., government, regulatory, industry, entity, enterprise, etc.). A reporting status display 1400 provides a user interface that allows users to understand not only the status of reporting, but to quickly understand where actions are required, reasons for reporting delays, and the like. The reporting status display 1400 may provide display options as to the relevant reporting to display, such as all reports, only certain reports (e.g. for particular regulators, for particular business units, etc.), only certain types of reports (e.g., all regulatory, all business units, etc.), or combinations thereof.

Reporting status visualization display component 1402 includes visualizations related to the status of reporting, such as interconnected and selectable nodes providing a variety of information at different levels of granularity. For example, top level nodes may include reporting statuses such as “Active,” “Queue,” “Submitted,” or “Accepted,” with each including one or more levels of sub-statuses. Aspects of the status visualization display component 1402 may be changed, such as the types and criteria of statuses, and sub-statuses. Selection of any portion of the visualization display component 1402 may result in a detailed display of associated reports at report details display component 1404, which may include a display of relevant information such as report number, report ID for the receiving entity, report types, status, individuals or units involved in the submission, and other relevant information. Selecting a report or subset of reports may result in a display of additional detailed information for the report(s), including the report itself or underlying report information at a variety of levels of granularity.

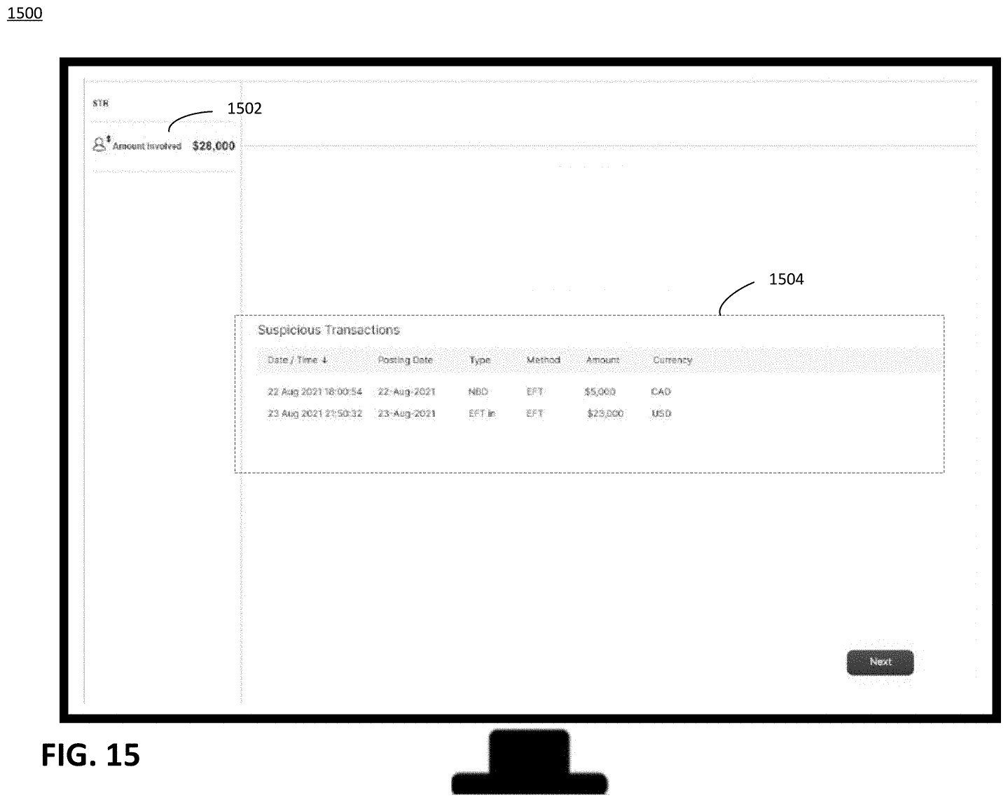

FIG. 15 depicts an improved user interface 1500 of the evaluation system including a suspicious activity display. The suspicious activity display 1500 includes a suspicious activity identification display component 1502 and a suspicious activity details component 1504, although other components may be added in other embodiments. Suspicious activity may be identified in a variety of manners, for example, in an automated manner based on business entity or regulator criteria, or based on a user identification of a suspicious transaction (e.g., based on review of activity and tagging of a transaction user the user interfaces described herein). Suspicious activity display 1500 may be accessed via a variety of other user interfaces as described herein, and the particular transactions or set of transactions selected for review via suspicious activity display 1500 may be selected or modified in a variety of manners.

Suspicious activity identification display component 1502 depicts the particular suspicious activity that has been selected for detailed review. User options may allow for selection of the information that is displayed within suspicious activity identification display component 1502, which in the embodiment of FIG. 15 may include an amount involved in the transaction. Although only one suspicious activity identification display component 1502 is displayed in FIG. 15, in some embodiments multiple suspicious activity identification display components 1502 may be displayed (e.g., each including a respective dollar amount) associated with a transaction or set of transactions.

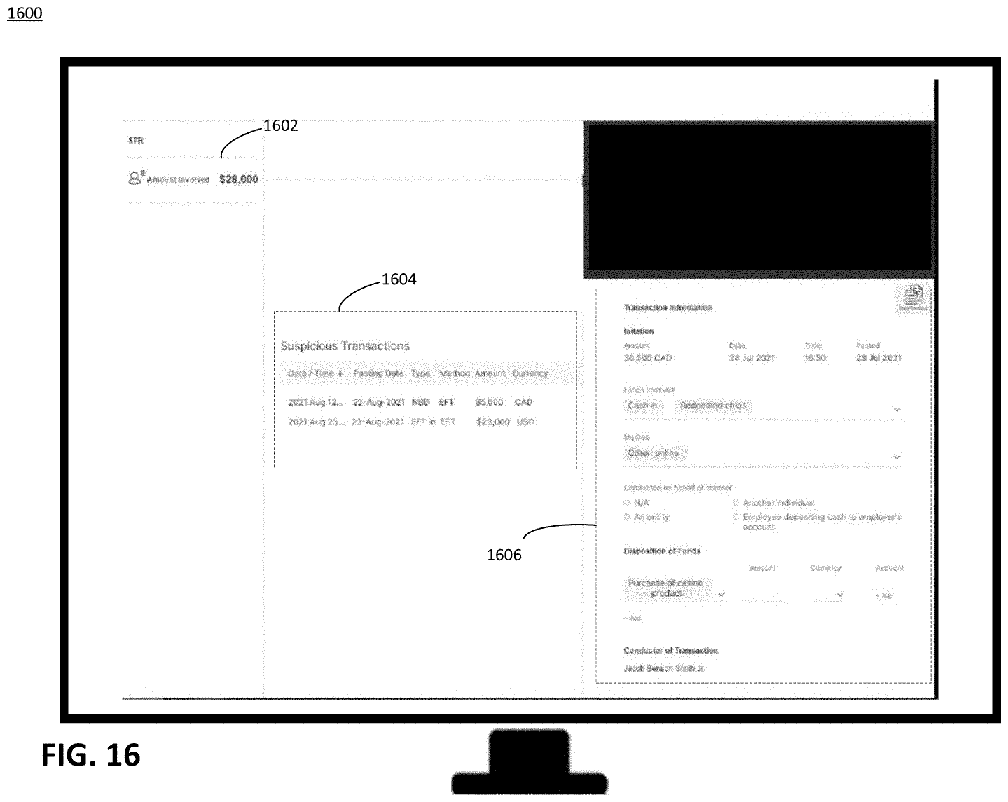

Suspicious activity details component 1504 includes a display of partial detailed information associated with the particular suspicious activity. Although depicted as a table with selectable and sortable columns, it will be understood that other depictions (e.g., visual indicators with only key information) may be provided in other embodiments and that information may be prioritized or emphasized in a variety of suitable manners (e.g., highlighting, changing coloring or intensity, or other emphasis) such as to show reported transactions that are indicative of activity that may require further action. The detailed information may include any suitable information as required for the particular suspicious activity, such as transaction identifiers, customer identifiers, type of activity, reason for suspicious activity designation, currency, location, time, etc. Each suspicious item may be selectable to provide further information, allow for user action related to a reported action (e.g., commenting or approval override), or modification of the manner of display of reported items. An example of such a detailed selection is provided in FIG. 16.

FIG. 16 depicts an improved user interface 1600 of the evaluation system including a selection of suspicious activity details within a suspicious activity display 1600. The suspicious activity display 1600 includes a suspicious activity identification display component 1602 (e.g., as described for suspicious activity display component 1502 for FIG. 15) and a suspicious activity details component 1604 (e.g., as described for suspicious activity details component 1504 for FIG. 15), and additionally includes a suspicious activity transaction information display 1606. Although suspicious activity transaction information display component 1606 may be accessed and displayed in a variety of manners, in an embodiment the display may be adjacent and partially overlaying the suspicious activity display to allow for ease of use and association with related information.

Suspicious activity transaction information display component 1606 includes a display of detailed information associated with a particular transaction related to the particular suspicious activity. Although depicted as an interactive GUI with various selectable and fixed options, it will be understood that other depictions and selection options may be provided in other embodiments and that information may be prioritized or emphasized in a variety of suitable manners (e.g., highlighting, changing coloring or intensity, or other emphasis) such as to show information that is directly related to the designation of the transaction as being related to suspicious activity. The detailed information may include any suitable information as required for the particular suspicious activity, such as transaction identifiers, customer identifiers, type of activity, reason for suspicious activity designation, currency, location, fund types involved, method of access, third-parties involved in the transaction, disposition of funds, entities or persons conducting transaction, etc. Aspects of the suspicious activity transaction information display component 1606 may be user-modifiable such as to change thresholds, suspicious activity designation criteria, manual overrides, commenting, and other related actions.

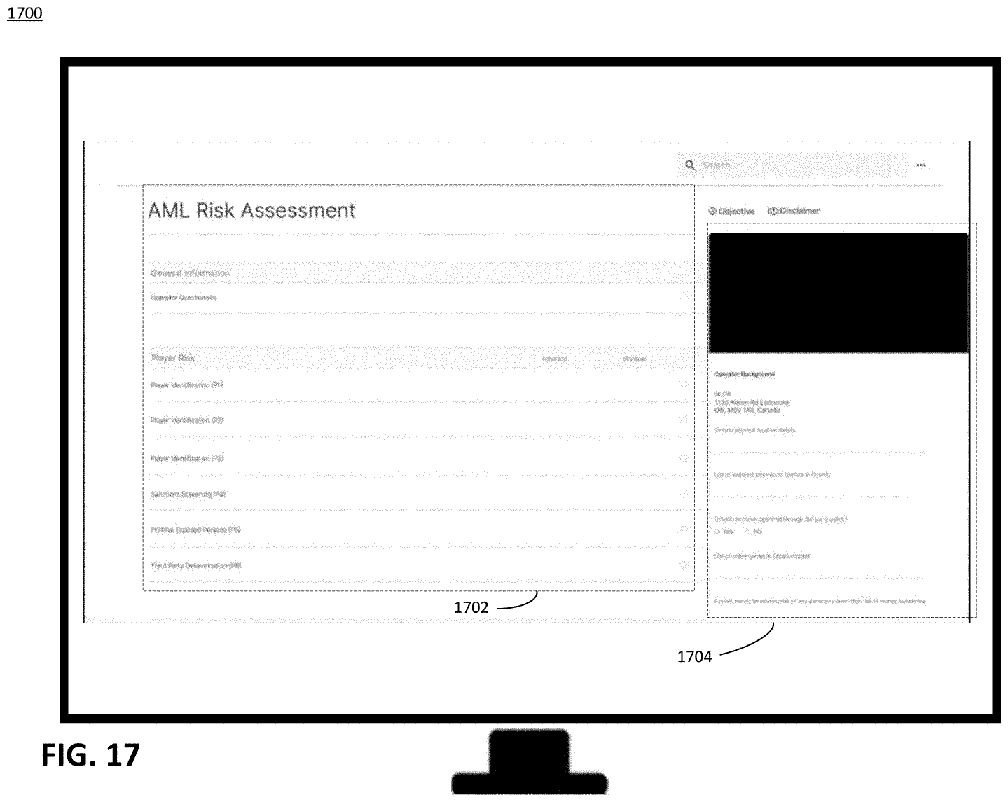

FIG. 17 depicts an improved user interface 1700 of the evaluation system including a risk assessment workflow display 1700. The risk assessment workflow display 1700 may include a workflow display component 1702 and a workflow item detail component 1704 that display simultaneously based on user selection, allowing for a user of the system to modify particular items within the risk assessment workflow without leaving the overall risk analysis process. Although other display components may be included in some embodiments, components may be removed, or the relative position and orientation of display components may be modified in some embodiments, as shown in FIG. 17 a risk assessment workflow display component 1702 includes a display of risk assessment workflow items to be performed while a workflow item detail display component 1704 includes structured and modifiable detailed information related to such underlying workflow items.

Workflow display component 1702 provides a navigable interface display workflow items for a particular risk assessment process. For example, workflow processes may be required by a business entity, regulator, government body, etc. These may be displayed individually for a particular workflow or combined such that common items may be completed for multiple workflows. Information about particular workflow items may be emphasized, such as by highlighting, coloring, intensity of display, icons, etc., to provide information such as status of the workflow item (completed, in process, critical, etc.), type of workflow item (e.g., which risk assessment an item is associated with), and other related information. Ordering and/or placement of workflow items may be modified based on similar criteria. Although workflow display component 1702 is displayed as a table of workflow items, it will be understood that other displays such as icons or grids may be utilized. Selection of a workflow item within workflow display component 1702 may result in the display of workflow item detail display component 1704. Workflow item detail display component 1704 provides an interface for interacting with a particular workflow item, such as providing for data entry and modification, selection of relevant information for incorporation of the workflow, commenting, submittals, overrides, and similar operations.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should be noted, the systems and/or methods described above may be applied to, or used in accordance with, other systems and/or methods.

What is claimed is:

1. A system for improved display of data for evaluating information for a selected person, comprising:
an input/output circuitry configured to:
receive a request for evaluating the selected person who is associated with the information;
a networking circuitry configured to:
transmit, via a first network, a first request for first data associated with the selected person using an internal data source;
transmit, via a second network, a second request for second data associated with the selected person using an external data source;
a control circuitry configured to:
calculate a plurality of assessment scores for a plurality of evaluation categories based on the first data from the internal data source and the second data from the external data source; and
calculate a combined scored based on the plurality of assessment scores and based on a weight associated with each of the plurality of evaluation categories;
wherein the input/output circuitry is further configured to:
generate for simultaneous display: (a) an identifier of the selected person; and (b) a visual representation of the calculated combined score associated with the selected person.

2. The system of claim 1, wherein the control circuitry is further configured to:
identify a plurality of additional persons that are identified as related to the selected person;
determine an additional combined scored associated with each of the additional persons; and
wherein the input/output circuitry is further configured to generate for simultaneous display with (a) the identifier of the selected person and (b) the visual representation of the calculated combined score associated with the selected person, (c) identifiers for each of the plurality of additional persons; and (d) a visual representation of each of the additional combined scores.

3. The system of claim 2, wherein the input/output circuitry is further configured to generate for display a visual representation of relationships between the selected person and the plurality of additional persons.

4. The system of claim 3, wherein the visual representation of the relationships is displayed simultaneously with the visual representation of each of the additional combined scores.

5. The system of claim 3, wherein the visual representation of the relationships is displayed in response to a user input requesting a view of the relationships.

6. The system of claim 1, wherein the input/output circuitry is further configured to generate for display a user interface for receiving input that specifies one or more of the weights associated with the plurality of evaluation categories.

7. The system of claim 1, wherein the input/output circuitry is further configured to generate for display a user interface for receiving input that specifies the plurality of evaluation categories out of a superset of evaluation categories.

8. The system of claim 1, wherein the input/output circuitry is further configured to generate for display a user interface for receiving a manually inputted assessment score for at least one of the plurality of evaluation categories.

9. The system of claim 1,
wherein the input/output circuitry is further configured to generate for display a secure messaging interface for communication with an external system that evaluates the selected person; and
wherein the networking circuitry is further configured to:
receive a message input relating to the selected person, via the secure messaging interface; and
transmit an encrypted version of the message to the external system.

10. The system of claim 9, wherein the transmission of the encrypted version of the message to the external system comprises sending the encrypted version of the message via an encrypted email.

11. The system of claim 10,
wherein the networking circuitry is further configured to receive, from the external system, a second encrypted email that was sent in response to the transmitting of the encrypted email;
wherein the control circuitry is further configured to decrypt the second encrypted email; and
wherein the input/output circuitry is further configured to generate for display decrypted content of the second encrypted email via the secure messaging interface.

12. The system of claim 1, wherein the networking circuitry is further configured to transmit the combined score to a validation system to cause the validation system to validate the information for the selected person in response to a comparison of the combined score of the selected person with a threshold.

13. The system of claim 12, wherein the validation of the information for the selected person comprises to prevent a transaction associated with selected person in response to the comparison of the combined score of the selected person with the threshold.

14. A method for improved display of data for evaluating information for a selected person, the method comprising:
receiving a request for evaluating the selected person who is associated with the information;
acquiring first data associated with the selected person using an internal data source;
acquiring second data associated with the selected person using an external data source;
calculating a plurality of assessment scores for a plurality of evaluation categories based on the first data from the internal data source and the second data from the external data source;
calculating a combined scored based on the plurality of assessment scores and based on a weight associated with each of the plurality of evaluation categories; and
generating for simultaneous display: (a) an identifier of the selected person; and (b) a visual representation of the calculated combined score associated with the selected person.

15. The method of claim 14, further comprising:
identifying a plurality of additional persons that are identified as related to the selected person; and
generating for simultaneous display with (a) the identifier of the selected person and (b) the visual representation of the calculated combined score associated with the selected person, (c) identifiers for each of the plurality of additional persons; and (d) a visual representation of each of the additional combined scores.

16. The method of claim 15, further comprising generating for display a visual representation of relationships between the selected person and the plurality of additional persons.

17. The method of claim 16, wherein the visual representation of the relationships is displayed simultaneously with the visual representation of each of the additional combined scores.

18. The method of claim 16, wherein the visual representation of the relationships is displayed in response to a user input requesting a view of the relationships.

19. The method of claim 14, further comprising generating for display a user interface for receiving input that specifies one or more of the weights associated with the plurality of evaluation categories.

20. The method of claim 14, further comprising generating for display a user interface for receiving input that specifies the plurality of evaluation categories out of a superset of evaluation categories.

21. The method of claim 14, further comprising generating for display a user interface for receiving a manually inputted assessment score for at least one of the plurality of evaluation categories.

22. The method of claim 14, further comprising:
generating for display a secure messaging interface for communication with an external system that evaluates the selected person;
receiving a message input relating to the selected person, via the secure messaging interface;
and transmitting an encrypted version of the message to the external system.

23. The method of claim 22, wherein the transmitting of the encrypted version of the message to the external system comprises sending the encrypted version of the message via encrypted email.

24. The method of claim 23, further comprising:
receiving, from the external system, a second encrypted email that was sent in response to the transmitting of the encrypted email;
decrypting the second encrypted email; and
generating for display decrypted content of the second encrypted email via the secure messaging interface.

25. The method of claim 14, wherein a comparison of the combined score with a threshold causes the information for the selected person to be validated.

26. The method of claim 24, wherein the validation of the information for the selected person comprises to prevent a transaction associated with selected person in response to the comparison of the combined score with the threshold.

27. A non-transitory computer-readable medium having instructions stored thereon, that when executed by control circuitry of an evaluation system causes the control circuitry to perform operations comprising:
receiving a request for evaluating a selected person who is associated with information to be evaluated;
acquiring first data associated with the selected person using an internal data source;
acquiring second data associated with the selected person using an external data source;
calculating a plurality of assessment scores for a plurality of evaluation categories based on the first data from the internal data source and the second data from the external data source;
calculating a combined scored based on the plurality of assessment scores and based on a weight associated with each of the plurality of evaluation categories; and
generating for simultaneous display: (a) an identifier of the selected person; and (b) a visual representation of the calculated combined score associated with the selected person.
